(19) United States
(12) Patent Application Publication
(10) Pub. No.: US 2024/0106004 A1
(43) Pub. Date: Mar. 28, 2024

(54) BATTERY AND METHOD FOR MANUFACTURING BATTERY

(71) Applicant: Panasonic Intellectual Property Management Co., Ltd., Osaka (JP)

(72) Inventors: MIHO UEHARA, Osaka (JP); KAZUHIRO MORIOKA, Osaka (JP); AKIRA KAWASE, Osaka (JP); SEIJI NISHIYAMA, Osaka (JP)

(21) Appl. No.: 18/533,251

(22) Filed: Dec. 8, 2023

Related U.S. Application Data
(63) Continuation of application No. PCT/JP2022/018145, filed on Apr. 19, 2022.

(30) Foreign Application Priority Data
Jun. 24, 2021 (JP) 2021-104800

(51) Int. Cl. H01M 10/0585; H01M 4/62; H01M 4/72

(52) U.S. Cl. CPC H01M 10/0585; H01M 4/628; H01M 4/72

(57) ABSTRACT

A battery includes a power-generating element and an insulating layer. The power-generating element includes an electrode layer, a counter-electrode layer placed to face the electrode layer, and a solid electrolyte layer located between the electrode layer and the counter-electrode layer. The insulating layer includes a first insulating film that extends inward from ends of the power-generating element in a planar view of a principal surface of the power-generating element and a second insulating film that covers a side surface of the power-generating element and that is continuous with ends of the first insulating film. The second insulating film is thinner than the first insulating film.

### BACKGROUND

### 1. Technical Field

The present disclosure relates to a battery and a method for manufacturing a battery.

### 2. Description of the Related Art

International Publication No. 2012/164642 and Japanese Unexamined Patent Application Publication No. 2016-207286 each disclose a battery including an insulating member.

### SUMMARY

The conventional technology is required to improve the reliability of a battery.

One non-limiting and exemplary embodiment provides a highly reliable battery.

In one general aspect, the techniques disclosed here feature a battery including a power-generating element and an insulating layer. The power-generating element includes an electrode layer, a counter-electrode layer placed to face the electrode layer, and a solid electrolyte layer located between the electrode layer and the counter-electrode layer. The insulating layer includes a first insulating film that extends inward from ends of the power-generating element in a planar view of a principal surface of the power-generating element and a second insulating film that covers a side surface of the power-generating element and that is continuous with ends of the first insulating film. The second insulating film is thinner than the first insulating film.

The present disclosure makes it possible to provide a highly reliable battery.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a top view showing an example of a battery according to Embodiment 1;

FIG. 2 is a cross-sectional view taken along line II-II in FIG. 1;

FIG. 3 is a cross-sectional view showing an example of a battery according to a comparative example;

FIG. 4 is a cross-sectional view showing an example of a laminated body in Manufacturing Method Example 1 for manufacturing a battery according to Embodiment 1;

FIG. 5 is a cross-sectional view for explaining a cutting step of Manufacturing Method Example 1 for manufacturing a battery according to Embodiment 1;

FIG. 6 illustrates a top view and a cross-sectional view showing an example of a collector with an insulator formed thereon in Manufacturing Method Example 2 for manufacturing a battery according to Embodiment 1;

FIG. 7 is a cross-sectional view showing an example of a laminated body in Manufacturing Method Example 2 for manufacturing a battery according to Embodiment 1;

FIG. 8 is a cross-sectional view for explaining a cutting step of Manufacturing Method Example 2 for manufacturing a battery according to Embodiment 1;

FIG. 9 is a cross-sectional view for explaining a laminated body forming step of Manufacturing Method Example 3 for manufacturing a battery according to Embodiment 1;

FIG. 10 is a cross-sectional view showing an example of a laminated body in Manufacturing Method Example 3 for manufacturing a battery according to Embodiment 1;

FIG. 11 is a cross-sectional view showing an example of a laminated body in Manufacturing Method Example 4 for manufacturing a battery according to Embodiment 1;

FIG. 12 is a cross-sectional view showing an example of a battery according to Modification 1 of Embodiment 1;

FIG. 13 is a cross-sectional view showing an example of a battery according to Modification 2 of Embodiment 1;

FIG. 14 is a cross-sectional view showing an example of a battery according to Modification 3 of Embodiment 1;

FIG. 15 is a cross-sectional view showing an example of a battery according to Modification 4 of Embodiment 1;

FIG. 16 is a cross-sectional view showing an example of a battery according to Modification 5 of Embodiment 1;

FIG. 17 is a cross-sectional view showing an example of a battery according to Embodiment 2;

FIG. 18 is a cross-sectional view showing an example of a battery according to a modification of Embodiment 2;

FIG. 19 is a cross-sectional view showing an example of a laminated body in a method for manufacturing a battery according to the modification of Embodiment 2; and

FIG. 20 is a cross-sectional view for explaining a cutting step of the method for manufacturing a battery according to the modification of Embodiment 2.

### DETAILED DESCRIPTIONS

### Underlying Knowledge Forming Basis of the Present Disclosure

In a case where a battery such as an all-solid battery including a solid electrolyte layer containing a solid electrolyte is manufactured, it is common to make the area of a negative-electrode active material layer larger than the area of a positive-electrode active material layer. This is intended to stabilize the performance of the battery and improve the reliability of the battery by making the capacitance of the negative-electrode active material layer larger than the capacitance of the positive-electrode active material layer to suppress, for example, deposition of metal derived from metal ions that were not incorporated into the negative-electrode active material layer. Further, this is also intended to improve the reliability of the battery by suppressing the concentration of electric fields at ends of the negative-electrode active material layer to inhibit dendrite growth (deposition of metal) at the ends. Further, in a case where the area of the negative-electrode active material layer is made larger, the solid electrolyte layer, for example, is disposed around the positive-electrode active material layer, which is placed to face the negative-electrode active material layer. This brings the positive-electrode active material layer out of contact with ends of a collector that tend to delaminate, thus enhancing the reliability also by reducing exposure of the positive-electrode active material layer even in a case where the ends of the collector delaminate.

However, it is difficult to manufacture a battery while precisely controlling the area of a positive-electrode active material layer and the area of a negative-electrode active material layer as just described. Further, for the purpose ensuring reliability, it is necessary to form the positive-electrode active material layer in consideration of the dimensional accuracy with which the positive-electrode active material layer is formed. This undesirably causes the positive-electrode active material layer to be small and causes the volume energy density of the battery to be low. Further, increasing the dimensional accuracy of the positive-electrode active material layer raises concern about an increase in the number of steps such as inspections and an increase in facility cost.

Further, forming the positive-electrode active material layer and the negative-electrode active material layer to ends of the battery for improvement in energy density makes a short circuit tend to occur at the ends of the battery.

To address this problem, the present disclosure provides a highly reliable battery. In particular, the present disclosure provides a highly reliable battery with an increased volume energy density.

The following gives a brief description of an aspect of the present disclosure.

A battery according to an aspect of the present disclosure includes a power-generating element and an insulating layer. The power-generating element includes an electrode layer, a counter-electrode layer placed to face the electrode layer, and a solid electrolyte layer located between the electrode layer and the counter-electrode layer. The insulating layer includes a first insulating film that extends inward from ends of the power-generating element in a planar view of a principal surface of the power-generating element and a second insulating film that covers a side surface of the power-generating element and that is continuous with ends of the first insulating film. The second insulating film is thinner than the first insulating film.

This allows the power-generating element to be protected from different directions by the first insulating film, which extends toward the inside of the power-generating element, and the second insulating film, which covers the side surface of the power-generating element. Further, by being thinner than the first insulating film, the second insulating film makes it hard for an external force to be applied to the second insulating film, making it hard for the second insulating film to delaminate from the side surface of the power-generating element. Further, even in a case where a force that delaminates the second insulating film is applied, delamination hardly propagates to the first insulating film, as the second insulating film is thinner. This inhibits the insulating layer as a whole from delaminating. Therefore, the present aspect makes it possible to enhance the reliability of the battery by effectively protecting the power-generating element with the insulating layer.

Further, for example, the electrode layer may include an electrode collector and an electrode active material layer located between the electrode collector and the solid electrolyte layer, and the first insulating film may be located between the electrode collector and the electrode active material layer.

For this reason, even if ends of the electrode collector delaminate, exposure of the electrode collector or the electrode active material layer is reduced by the first insulating film, so that it becomes hard for damage, a short circuit, or other failures to occur due to contact between the electrode collector or the electrode active material layer and another member. This makes it possible to enhance the reliability of the battery.

Further, for example, the second insulating film may cover the electrode active material layer and the solid electrolyte layer on the side surface of the power-generating element.

This causes the insulating layer to continuously cover an area from a principal surface of the electrode active material layer to at least part of the solid electrolyte layer across a side surface of the electrode active material layer, preventing corners of the electrode active material layer from being exposed even in a case where the ends of the electrode collector delaminate. This makes it hard for the electrode active material layer to become damaged, bringing about improvement in reliability of the battery.

Further, for example, the electrode layer may include an electrode collector and an electrode active material layer located between the electrode collector and the solid electrolyte layer, and the first insulating film may be located between the electrode active material layer and the solid electrolyte layer.

This allows the first insulating film to enter a gap between materials that constitute the electrode active material layer and the solid electrolyte layer, making it hard for the electrode active material layer and the solid electrolyte layer to delaminate.

Further, for example, the electrode layer may be a positive-electrode layer, and the counter-electrode layer may be a negative-electrode layer.

In this way, electrons from the electrode collector or ions from the solid electrolyte layer hardly reach a portion of the electrode active material layer that is in a region that overlaps the first insulating film in planar view, i.e., the positive-electrode active material layer, so that the positive-electrode active material layer of that region hardly functions as an electrode. This brings about an effect of substantially reducing the area of the positive-electrode active material layer. As a result, the area of the positive-electrode active material layer tends to be substantially smaller than the area of the counter-electrode layer, i.e., the negative-electrode layer. Therefore, the capacitance of the negative-electrode layer tends to be larger than the capacitance of the positive-electrode layer. This suppresses deposition of metal derived from metal ions that were not incorporated into the negative-electrode layer, making it possible to further enhance the reliability of the battery.

Further, for example, the first insulating film may be located in a region where a length of the electrode active material layer from an outer periphery in a plan view of the principal surface of the power-generating element is shorter than or equal to 1 mm.

In this way, a region where the presence of the first insulating film makes it hard for the electrode active material layer to function as an electrode can fall within a range of distances shorter than or equal to a certain distance from the outer periphery of the electrode active material layer. This makes it possible to increase the volume energy density of the battery.

Further, for example, the second insulating film may include a first portion extending from the ends of the first insulating film in a first direction along the side surface of the power-generating element and a second portion extending from the ends of the first insulating film in a second direction opposite to the first direction along the side surface of the power-generating element.

This causes regions of the side surface of the power-generating element located on both sides of the first insulating film in a direction of laminating to be covered with the second insulating film. This makes it possible to further enhance the reliability of the battery.

Further, for example, the electrode layer may include an electrode collector and an electrode active material layer located between the electrode collector and the solid electrolyte layer, and the first insulating film may face the electrode active material layer across the electrode collector.

This causes the insulating layer to continuously cover an area from the top of the electrode collector to the side surface of the power-generating element, thus making it hard for the electrode collector to delaminate.

Further, for example, the second insulating film may cover the electrode collector, the electrode active material layer, and the solid electrolyte layer on the side surface of the power-generating element.

This causes the second insulating film to cover the whole of the electrode layer, which includes the electrode collector and the electrode active material layer, along the direction of laminating on the side surface of the power-generating element, thus making it possible to reduce the risk of a short circuit in the electrode layer.

Further, for example, the insulating layer may contain resin.

This makes it possible to enhance the bondability between the insulating layer and the power-generating element through an anchoring effect by which the resin contained in the insulating layer penetrates into a material constituting the power-generating element, making it possible to inhibit the insulating layer from delaminating.

Further, for example, the second insulating film may cover a region of the side surface of the power-generating element, and a region of the side surface of the power-generating element that is not covered with the second insulating film and a surface of the second insulating film that faces away from the power-generating element may be flush with each other.

This causes a side surface of the battery to be a flat surface and prevents the formation of a space that does not function as a battery, thus bringing about improvement in substantive volume energy density of the battery.

Further, for example, a thickness of the second insulating film may become smaller away from the first insulating film.

This reduces the thickness of an end of the second insulating film at which delamination tends to start and that is away from the first insulating film, thus making it harder for the second insulating film to delaminate from the side surface.

Further, for example, the solid electrolyte layer may contain a solid electrolyte having lithium ion conductivity.

This makes it possible to enhance the battery reliability of a lithium-ion battery containing a solid electrolyte.

Further, a method for manufacturing a battery according to an aspect of the present disclosure includes forming a laminated body including a power-generating element in which an electrode layer, a counter-electrode layer placed to face the electrode layer, and a solid electrolyte layer located between the electrode layer and the counter-electrode layer are laminated and an insulator placed in a position that overlaps the power-generating element in a planar view of a principal surface of the power-generating element and cutting the laminated body with a cutting edge in a direction across the principal surface of the power-generating element so that the cutting edge passes through the insulator and thereby forming a cut surface of the power-generating element. The cutting may include cutting the laminated body while applying the insulator to the cut surface with the cutting edge.

This makes it possible to, by forming the cut surface with the cutting edge passing through the insulator, manufacture a battery in which the insulator is placed at ends of the power-generating element. Further, since the cutting edge cuts the laminated body while applying the insulator to the cut surface of the power-generating element, the side surface of the power-generating element is formed at the same time as the laminated body is cut, so that the cut surface, on which the layers of the power-generating element are exposed, can be protected by the insulator. This makes it possible to manufacture a highly reliable battery in a simple way. Further, since a portion of the insulator that adhered to the cutting edge when the cutting edge passed through the insulator is applied to the cut surface, the insulator tends to be applied in small amounts, so that a thin-film insulator can be applied to the cut surface. This makes it hard for an external force to be applied to the insulator applied to the cut surface, making it hard for the insulator thus applied to delaminate from the side surface. This further enhances the reliability of the battery to be manufactured.

Further, for example, the cutting may include cutting the laminated body while applying a pressure to the laminated body in a direction of laminating.

This causes the insulator to be pushed out toward the cut surface, so that it becomes easy for the insulator to adhere to the cutting edge. This makes it possible to stably apply the insulator to the cut surface. Further, adjusting the pressure makes it possible to adjust an amount of the insulator that is pushed out toward the cut surface, thus making it easy to form the insulator into a desired shape while applying the insulator to the cut surface.

Further, for example, the insulator may be constituted by a thermoplastic material, and the cutting may include cutting the laminated body after heating at least one of the laminated body or the cutting edge to a temperature that is higher than or equal to a softening point of the insulator.

This makes it possible to heat the insulator into a flowable state and apply the insulator to the cut surface. Further, adjusting the temperature to which the insulator is heated makes it possible to adjust the viscosity of the insulator, making it easy to form the insulator into a desired shape while applying the insulator to the cut surface.

Further, for example, in the cutting, the temperature may be lower than or equal to 300° C.

This makes it hard for the materials of the layers of the power-generating element to suffer decomposition, alternation, or other changes in quality, making it possible to reduce deterioration of the power-generating element in the manufacturing process.

Further, for example, the cutting may include heating both the laminated body and the cutting edge, and the heating of the laminated body and the cutting edge may include heating the laminated body to a first temperature and heating the cutting edge to a second temperature that is higher than the first temperature.

This causes the cutting edge, which applies the insulator, to be heated to a higher temperature, thus making it possible to effectively fluidize the insulator near the cut surface and apply the insulator to the cut surface.

Further, for example, the insulator may be constituted by a thermosetting material or a photocurable material, and the cutting may include curing the insulator after cutting the laminated body.

Thus, the insulator can be easily applied to the cut surface without heating or other processes during the cutting of the laminated body. This makes it possible to reduce deterioration of the materials of the layers of the power-generating element by heat and simplify cutting equipment. Further, adjusting the viscosity of the curable material before curing makes it easy to form the insulator into a desired shape while applying the insulator to the cut surface.

Further, for example, the forming may include forming the laminated body by inserting the insulator into a side surface of the power-generating element.

This makes it possible to form the laminated body simply by inserting the insulator into the side surface of the power-generating element after laminating the layers of the power-generating element.

The following describes embodiments in concrete terms with reference to the drawings.

It should be noted that the embodiments to be described below each illustrate a comprehensive and specific example. The numerical values, shapes, materials, constituent elements, placement and topology of constituent elements, or other features that are shown in the following embodiments are just a few examples and are not intended to limit the present disclosure. Further, those of the constituent elements in the following embodiments which are not recited in an independent claim are described as optional constituent elements.

Further, terms such as “parallel” and “flush” used herein to show the way in which elements are interrelated, terms such as “flat” and “rectangular” used herein to show the shape of an element, and ranges of numerical values used herein are not expressions that represent only exact meanings but expressions that are meant to also encompass substantially equivalent ranges, e.g., differences of approximately several percent.

Further, the drawings are schematic views, and are not necessarily strict illustrations. In the drawings, substantially the same components are given the same reference signs, and a repeated description may be omitted or simplified.

Further, in the present specification and drawings, the x axis, the y axis, and the z axis represent the three axes of a three-dimensional orthogonal coordinate system. In each of the embodiments, the z-axis direction is a direction of laminating of a battery. Further, the term “direction of laminating” as used herein corresponds to a direction normal to principal surfaces of a collector and an active material layer. Further, the term “planar view” used herein means a case where the battery is seen from an angle parallel with the z axis, unless otherwise noted, for example, in a case where the term is used alone.

Further, the terms “above” and “below” in the configuration of a battery used herein do not refer to an upward direction (upward in a vertical direction) and a downward direction (downward in a vertical direction) in absolute space recognition, but are used as terms that are defined by a relative positional relationship on the basis of an order of laminating in a laminate configuration. Further, the terms “above” and “below” are applied not only in a case where two constituent elements are placed at a spacing from each other with another constituent element present between the two constituent elements, but also in a case where two constituent elements touch each other by being placed in close contact with each other. In the following description, the negative side of the z axis is referred to as “below” or “lower”, and the positive side of the z axis is referred to as “above” or “upper”.

### EMBODIMENT 1

The following describes a battery according to Embodiment 1. The battery according to Embodiment 1 is a single cell including one electrode active material layer and one counter-electrode active material layer. Therefore, the battery according to Embodiment 1 includes one power-generating element.

### Configuration

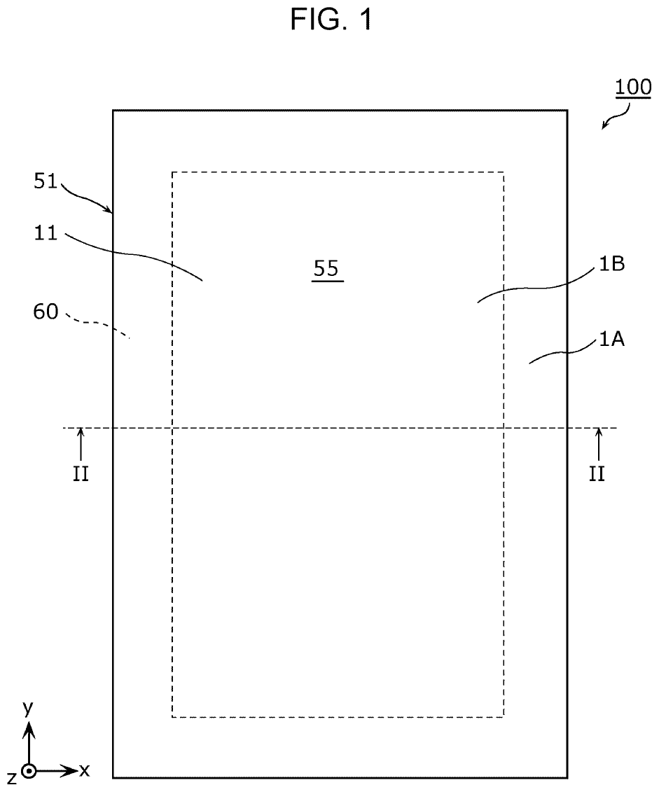

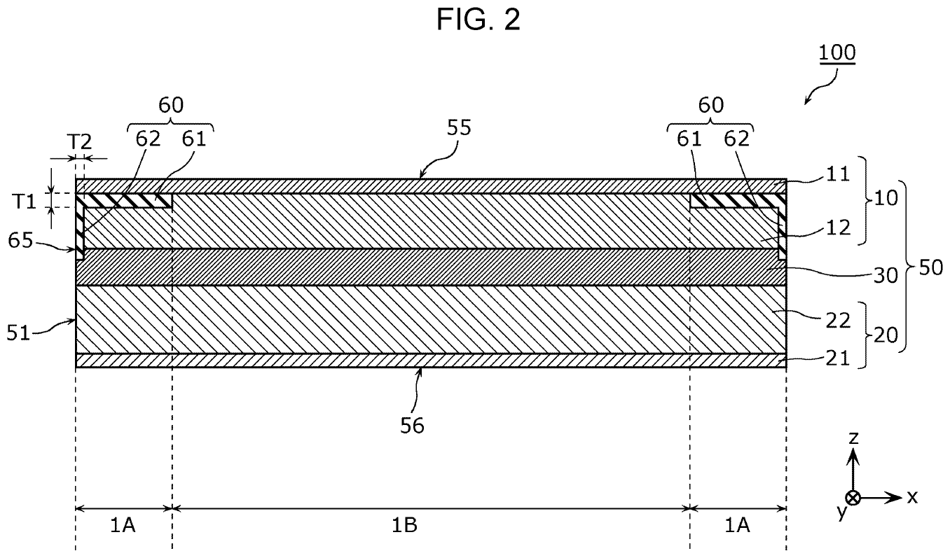

First, a configuration of the battery according to Embodiment 1 is described with reference to the drawings. FIG. 1 is a top view showing an example of a battery according to the present embodiment. FIG. 2 is a cross-sectional view as taken along line II-II in FIG. 1.

As shown in FIGS. 1 and 2, the battery 100 according to the present embodiment includes a power-generating element 50 and an insulating layer 60. The power-generating element 50 includes an electrode layer 10, a counter-electrode layer 20 placed to face the electrode layer 10, and a solid electrolyte layer 30 located between the electrode layer 10 and the counter-electrode layer 20. The insulating layer 60 is located on the outer periphery of the power-generating element 50 in a planar view of a principal surface 55 of the power-generating element 50. The battery 100 is for example an all-solid battery.

The power-generating element 50 has a structure in which the electrode layer 10, the solid electrolyte layer 30, and the counter-electrode layer 20 are laminated in this order.

The electrode layer 10 includes a collector 11 and an electrode active material layer 12 located between the collector 11 and the solid electrolyte layer 30. The collector 11 is an example of an electrode collector.

The counter-electrode layer 20 includes a collector 21 and a counter-electrode active material layer 22 located between the collector 21 and the solid electrolyte layer 30.

The power-generating element 50 has two principal surfaces 55 and 56 that face each other and a side surface 51 that connects the principal surface 55 with the principal surface 56.

The side surface 51 of the power-generating element 50 is for example a cut surface. Specifically, the side surface 51 of the power-generating element 50 is a surface formed by being cut with the cutting edge of a cutter or other tools for cutting. Further, the side surface 51 is a surface to which an insulator is applied at the time of cutting in the after-mentioned cutting step. The side surface 51 of the power-generating element 50 is for example a surface having traces of cutting such as fine grooves. Since the power-generating element 50 has a cut surface formed by being thus cut, the location to form the insulating layer 60 can be adjusted. This makes it possible to reduce the area of a portion (i.e., a portion in which a first insulating film 61 of the insulating layer 60 is formed, which will be described in detail later) that does not contribute to the charge-discharge performance of the power-generating element 50, making it possible to bring about improvement in volume energy density. It should be noted that the traces of cutting may be smoothed by polishing or other processes. The shape of the cut surface is not limited; however, in the case of the power-generating element 50, the shape of the cut surface is a rectangle.

Further, in the power-generating element 50, the collector 11, the electrode active material layer 12, the solid electrolyte layer 30, the counter-electrode active material layer 22, and the collector 21 are substantially identical in shape and position to one another in planar view, although there is a layer having a slightly recessed portion covered with the after-mentioned thin second insulating film 62. Further, the planimetric shapes of the collector 11, the electrode active material layer 12, the solid electrolyte layer 30, the counter-electrode active material layer 22, and the collector 21 are rectangles, but are not limited to particular shapes and may be circles, ellipses, polygons, or other shapes. As mentioned above, the side surface 51 is a cut surface formed by cutting and applying an insulator. Therefore, the planimetric shapes can be arbitrarily designed depending on the intended use and, for example, may be formed into complex shapes such as heart shapes, star shapes, or character shapes.

The insulating layer 60 includes the first insulating film 61 and the second insulating film 62. The first insulating film 61 and the second insulating film 62 are formed, for example, by processing one insulator and constitute the insulating layer 60 as a single entity. Therefore, the first insulating film 61 and the second insulating film 62 can also be said to be names given to different parts of the insulating layer 60.

The insulating layer 60 contains a malleable material, such as resin, fat, wax, an elastomer, or a polysaccharide, that becomes flowable under given conditions. The resin may be thermoplastic resin or may be curable resin such as thermosetting resin or photocurable resin. Further, the insulating layer 60 may contain a metallic oxide, a mineral, ceramics, or other materials. The metallic oxide is for example silicon oxide, titanium oxide, aluminum oxide, or other metallic oxides. The insulating layer 60 may be constituted by a resin material containing resin and, when needed, a metallic oxide.

Since the insulating layer 60 contains the resin, the bondability between the insulating layer 60 and the power-generating element 50 can be enhanced, for example, through an anchoring effect by which the resin penetrates into the collector 11, the electrode active material layer 12, and the solid electrolyte layer 30. Further, since the resin can be fluidized for processing, the insulating layer 60 can be easily formed. Further, since the insulating layer 60 contains the metallic oxide, the insulating layer 60 hardens, so that the protection of the power-generating element 50 by the insulating layer 60 can be enhanced.

The first insulating film 61 is positioned to extend inward from ends of the power-generating element 50 in a planar view of the principal surface 55. The first insulating film 61 extends inward from the ends of the power-generating element 50, for example, along a direction parallel with the principal surface 55. A thickness direction of the first insulating film 61 corresponds to a direction normal to the principal surface 55. The first insulating film 61 overlaps the power-generating element 50 in planar view.

Further, the first insulating film 61 is located between the collector 11 and the electrode active material layer 12. A lower surface of the first insulating film 61 and inner side surfaces of the first insulating film 61 in planar view are in contact with the electrode active material layer 12. The first insulating film 61 is in contact with the electrode active material layer 12 at ends of the electrode layer 10 in planar view. An upper surface of the first insulating film 61 is in contact with the collector 11. Further, the first insulating film 61 overlaps the counter-electrode active material layer 22 in planar view.

In the illustrated example, the first insulating film 61 is located on the outer periphery of the power-generating element 50 and has the shape of a frame in planar view. That is, the first insulating film 61 is located between the collector 11 and the electrode active material layer 12 at all ends of the electrode layer 10 that extend in a direction perpendicular to the direction of laminating.

Further, the first insulating film 61 is located in a region where a length of the electrode active material layer 12 from the outer periphery, for example, in planar view is shorter than or equal to 1 mm from the point of view of an effective area that contributes to power generation, i.e., from the point of view of volume energy density. Further, a width of the first insulating film 61 in a case where the first insulating film 61 is formed in the shape of a frame or a line or other shapes is for example smaller than or equal to 1 mm, and may be smaller than or equal to 0.5 mm or may be smaller than or equal to 0.1 mm from the point of view of volume energy density. Further, the width of the first insulating film 61 may be greater than or equal to 0.05 mm or may be greater than or equal to 0.1 mm. The width of the first insulating film 61 is changed, for example, depending on battery characteristics required. The second insulating film 62 covers the side surface 51 of the power-generating element 50 and is continuous with ends of the first insulating film 61. The second insulating film 62 is continuous with the ends of the first insulating film 61 on the outer periphery of the power-generating element 50 in planar view. The second insulating film 62 extends toward the counter-electrode layer 20 along the side surface 51 from the ends of the first insulating film 61. This causes the side surface 51 to be protected by the second insulating film 62. A thickness direction of the second insulating film 62 is a direction perpendicular to the side surface 51. Further, the second insulating film 62 is disposed, for example, to surround the power-generating element 50 from the sides. It should be noted that the second insulating film 62 may not surround all sides of the power-generating element 50. For example, in a case where the planimetric shape of the power-generating element 50 is a complex shape, the second insulating film 62 may cover only places, such as recesses or corners, on side surfaces of the power-generating element 50 where a short circuit, damage, or other failures tend to occur.

The second insulating film 62 covers a region of the side surface 51. Specifically, the second insulating film 62 covers the electrode active material layer 12 and the solid electrolyte layer 30 on the side surface 51. The second insulating film 62 continuously covers an area from the electrode active material layer 12 to part of the solid electrolyte layer 30 on the side surface 51. This causes side surfaces of the electrode active material layer 12 to be covered by the second insulating film 62, thereby making it possible to reduce the risk of falling of a material of the electrode active material layer 12 and the risk of a short circuit in the electrode active material layer 12. Furthermore, since the electrode active material layer 12 is covered with the first insulating film 61 and the second insulating film 62 from an upper principal surface of the electrode active material layer 12 to the side surfaces, corners of the electrode active material layer 12 are not exposed even in a case where ends of the collector 11 delaminate. This makes it hard for the electrode active material layer 12 to become damaged, bringing about improvement in reliability of the battery 100.

Further, the second insulating film 62 does not cover at least part of the counter-electrode layer 20 on the side surface 51. In the present embodiment, the second insulating film 62 does not cover the counter-electrode layer 20 on the side surface 51. It should be noted that a region on the side surface 51 that the second insulating film 62 covers is not limited to a particular region. The second insulating film 62 may cover the whole of the solid electrolyte layer 30 on the side surface 51. Further, the second insulating film 62 may further cover the counter-electrode active material layer 22 or may further cover the counter-electrode active material layer 22 and the collector 21 on the side surface 51.

As will be mentioned in detail later, the second insulating film 62 is formed, for example, by the material of the insulating layer 60 being applied to the side surface 51 in cutting all layers of the power-generating element 50 at once so as to pass through a region where the material of the insulating layer 60 is located. Therefore, a region of the side surface 51 that is not covered with the second insulating film 62 and a surface 65 of the second insulating film 62 that faces away from the power-generating element 50 are flush with each other. That is, the region of the side surface 51 that is not covered with the second insulating film 62 and the surface 65 are in a stepless state, and lie in the same plane. This causes a side surface of the battery 100 to be a flat surface and prevents the formation of a space that does not function as a battery, thus bringing about improvement in substantive volume energy density of the battery 100. It should be noted that the surface 65 of the second insulating film 62 may be located further outward in planar view than the region of the side surface 51 that is not covered with the second insulating film 62.

The second insulating film 62 is thinner than the first insulating film 61. That is, a thickness T2 of the second insulating film 62 is smaller than a thickness T1 of the first insulating film 61. Such thinness of the second insulating film 62 makes it hard for an external force to be applied to the second insulating film 62, making it hard for the second insulating film 62 to delaminate from the side surface 51. Further, in a case where the second insulating film 62 contains resin or other materials and is bonded to the side surface 51 by an anchoring effect, the ratio of the material of the second insulating film 62 that penetrates due to the anchoring effect increases, so that there is improvement in bondability between the second insulating film 62 and the side surface 51. Further, even in a case where a force that delaminates the second insulating film 62 is applied, delamination hardly propagates to the first insulating film 61, as the second insulating film 62 is thinner. This inhibits the insulating layer 60 as a whole from delaminating. This brings about improvement in reliability of the battery 100. It should be noted that in a case where the first insulating film 61 and the second insulating film 62 are not uniform in thickness, for example, the thickness T1 of the first insulating film 61 is the thickness of an end of the first insulating film 61 on the outer periphery of the power-generating element 50 and the thickness T2 of the second insulating film 62 is the maximum thickness of the second insulating film 62.

The thickness T1 of the first insulating film 61 is for example greater than or equal to 11 μm and smaller than or equal to 300 μm. Further, the thickness T1 of the first insulating film 61 may be greater than or equal to 2 μm and smaller than or equal to 50 μm.

The thickness T2 of the second insulating film 62 is for example greater than or equal to 0.1 μm and smaller than or equal to 150 μm. Further, the thickness T2 of the second insulating film 62 may be greater than or equal to 0.5 μm and smaller than or equal to 20 μm.

The collector 11 is in contact with an upper surface of the electrode active material layer 12 and the upper surface of the first insulating film 61 and covers the upper surfaces of the electrode active material layer 12 and the first insulating film 61. At the ends of the collector 11 in planar view, the first insulating film 61 is laminated. The thickness of the collector 11 is for example greater than or equal to 5 μm and smaller than or equal to 100 μm.

As a material of the collector 11, a publicly-known material may be used. As the collector 11, a foil-like body, a plate-like body, a net-like body, or other bodies composed of, for example, copper, aluminum, nickel, iron, stainless steel, platinum, gold, an alloy of two or more types thereof, or other substances are used.

The electrode active material layer 12 is laminated below the collector 11 so as to cover the first insulating film 61 on the lower side of the collector 11. The upper surface of the electrode active material layer 12 is also in contact with the collector 11. A lower surface of the electrode active material layer 12 is in contact with the solid electrolyte layer 30. The electrode active material layer 12 and the counter-electrode active material layer 22 face each other across the solid electrolyte layer 30. The electrode active material layer 12 has a region that does not overlap the first insulating film 61 in planar view. Further, the electrode active material layer 12 is located further inward by the thickness T2 of the second insulating film 62 than the counter-electrode active material layer 22 in planar view. Further, since the thickness T2 of the second insulating film 62 is much smaller than the length of the electrode active material layer 12 in a direction parallel with the principal surface, the electrode active material layer 12 and the counter-electrode active material layer 22 are identical in shape and position to each other in planar view. Further, the electrode active material layer 12 and the counter-electrode active material layer 22 are substantially identical in area to each other. The thickness of the electrode active material layer 12 is for example greater than or equal to 5 μm and smaller than or equal to 300 μm. A material for use in the electrode active material layer 12 will be described later.

The collector 21 is in contact with a lower surface of the counter-electrode active material layer 22 and covers the lower surface of the counter-electrode active material layer 22. The thickness of the collector 21 is for example greater than or equal to 5 μm and smaller than or equal to 100 μm. As a material of the collector 21, the material of the aforementioned collector 11 may be used.

The counter-electrode active material layer 22 is laminated on the lower side of the solid electrolyte layer 30 and placed to face the electrode active material layer 12. The lower surface of the counter-electrode active material layer 22 is in contact with the collector 21. The thickness of the counter-electrode active material layer 22 is for example greater than or equal to 5 μm and smaller than or equal to 300 μm. A material for use in the counter-electrode active material layer 22 will be described later.

The solid electrolyte layer 30 is located between the electrode active material layer 12 and the counter-electrode active material layer 22. The thickness of the solid electrolyte layer 30 is for example greater than or equal to 5 μm and smaller than or equal to 150 μm.

The solid electrolyte layer 30 contains at least a solid electrolyte and, when needed, may contain a binder material. The solid electrolyte layer 30 may contain a solid electrolyte having lithium ion conductivity.

As the solid electrolyte, a publicly-known material such as a lithium ion conductor, a sodium ion conductor, or a magnesium ion conductor may be used. As the solid electrolyte, for example, a solid electrolyte material such as a sulfide solid electrolyte, a halogenated solid electrolyte, or an oxide solid electrolyte is used. In the case of a material that is able to conduct lithium ions, for example, a synthetic substance composed of lithium sulfide (Li₂S) and diphosphorous pentasulfide (P₂S₅) is used as the sulfide solid electrolyte. Further, as the sulfide solid electrolyte, a sulfide such as Li₂S—SiS₂, Li₂S—B₂S₃, or Li₂S—GeS₂ may be used, or a sulfide obtained by adding at least one type of Li₃N, LiCl, LiBr, Li₃PO₄, or Li₄SiO₄ as an additive to the aforementioned sulfide may be used.

In the case of a material that is able to conduct lithium ions, for example, Li₇La₃Zr₂O₁₂ (LLZ), Li_{1.3}Al_{0.3}Ti_{1.7}(PO₄)₃ (LATP), (La,Li)TiO₃ (LLTO), or other substances are used as the oxide solid electrolyte.

As the binder material, for example, elastomers are used, or an organic compound such as polyvinylidene fluoride, acrylic resin, or cellulose resin may be used.

In the present embodiment, either the electrode layer 10, which includes the electrode active material layer 12, or the counter-electrode layer 20, which includes the counter-electrode active material layer 22, is a positive-electrode layer including a positive-electrode active material layer, and the other is a negative-electrode layer including a negative-electrode active material layer.

The positive-electrode active material layer contains at least a positive-electrode active material and, when needed, may contain at least one of a solid electrolyte, a conductive auxiliary agent, and a binder material.

As the positive-electrode active material, a publicly-known material that is capable of occlusion and ejection (insertion and desorption or dissolution and deposition) of lithium ions, sodium ions, or magnesium ions may be used. In the case of a material that is capable of desorption and insertion of lithium ions, for example, a lithium cobalt oxide complex oxide (LCO), a lithium nickel oxide complex oxide (LNO), a lithium manganese oxide complex oxide (LMO), a lithium-manganese-nickel complex oxide (LMNO), a lithium-manganese-cobalt complex oxide (LMCO), a lithium-nickel-cobalt complex oxide (LNCO), a lithium-nickel-manganese-cobalt complex oxide (LNMCO), or other substances are used as the positive-electrode active material.

As the solid electrolyte, the aforementioned solid electrolyte material may be used. Further, as the conductive auxiliary agent, for example, a conducting material such as acetylene black, carbon black, graphite, or carbon fiber is used. Further, as the binder material, the aforementioned binder material may be used.

The negative-electrode active material layer contains at least a negative-electrode active material and, when needed, may contain at least one of a solid electrolyte, a conductive auxiliary agent, and a binder material similar to that of the positive-electrode active material layer.

As the negative-electrode active material, a publicly-known material that is capable of occlusion and ejection (insertion and desorption or dissolution and deposition) of lithium ions, sodium ions, or magnesium ions may be used. In the case of a material that is capable of desorption and insertion of lithium ions, for example, a carbon material such as natural graphite, synthetic graphite, graphite carbon fiber, or resin heat-treated carbon, metal lithium, a lithium alloy, an oxide of lithium and a transition metal element, or other substances are used as the negative-electrode active material.

In the case of manufacture of a battery, it is common, as mentioned above, to make the area of a negative-electrode active material layer larger than the area of a positive-electrode active material layer in planar view for the purpose of improving reliability. Furthermore, disposing ends of the negative-electrode active material layer further toward the outside than ends of the positive-electrode active material layer makes it possible to suppress the concentration of electric fields at the ends of the negative-electrode active material layer to inhibit dendrite growth (deposition of metal).

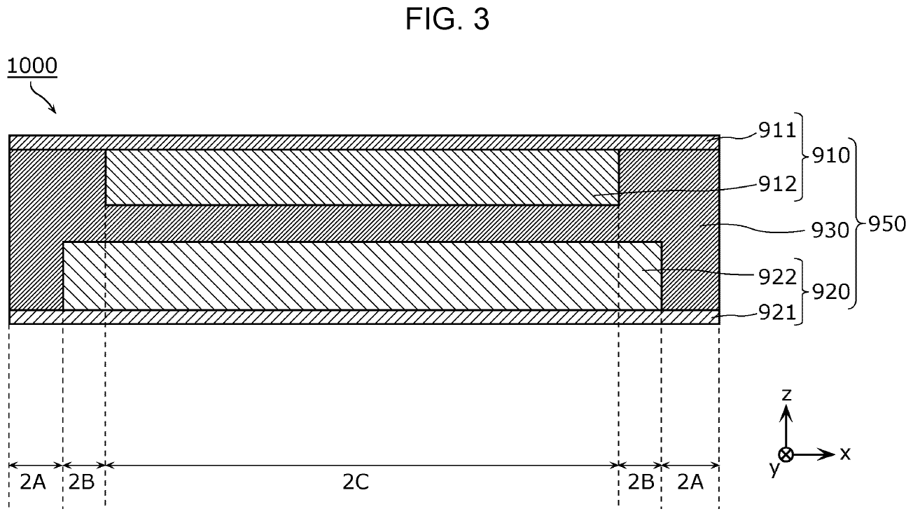

The following describes a battery 1000 according to a comparative example in which the area of a negative-electrode active material layer is larger than the area of a positive-electrode active material layer in planar view. FIG. 3 is a cross-sectional view showing an example of the battery according to the comparative example.

As shown in FIG. 3, the battery 1000 includes a power-generating element 950 including a positive-electrode layer 910, a negative-electrode layer 920, and a solid electrolyte layer 930 located between the positive-electrode layer 910 and the negative-electrode layer 920. The positive-electrode layer 910 includes a collector 911 and a positive-electrode active material layer 912 located between the collector 911 and the solid electrolyte layer 930. The negative-electrode layer 920 includes a collector 921 and a negative-electrode active material layer 922 located between the collector 921 and the solid electrolyte layer 930. The solid electrolyte layer 930 covers side surfaces of the positive-electrode active material layer 912 and the negative-electrode active material layer 922 and is in contact with the collector 911 and the collector 921. In a planar view of the battery 1000, the area of the negative-electrode active material layer 922 is larger than the area of the positive-electrode active material layer 912, and ends of the negative-electrode active material layer 922 are located further outward than ends of the positive-electrode active material layer 912. Thus, in the battery 1000, deposition of metal is suppressed by making the area of the negative-electrode active material layer 922 is larger than the area of the positive-electrode active material layer 912. Further, the presence of the solid electrolyte layer 930 at ends of the power-generating element 950 reduces exposure of the positive-electrode active material layer 912 and the negative-electrode active material layer 922 even in a case where the collector 911 and the collector 921 delaminate from the ends.

A region 2C where the positive-electrode active material layer 912 and the negative-electrode active material layer 922 are present functions as a battery. Meanwhile, a region 2A where neither the positive-electrode active material layer 912 nor the negative-electrode active material layer 922 is present does not function as a battery. Further, a region 2B where the negative-electrode active material layer 922 is present but the positive-electrode active material layer 912 is not present does not function as a battery, either. The region 2B is a region that is equivalent to the difference in area between the positive-electrode active material layer 912 and the negative-electrode active material layer 922. As the region 2B and the region 2A become wider in planar view, the proportion of regions in the battery 1000 that do not contribute to power generation increases, with the result that the volume energy density of the battery 1000 decreases. Meanwhile, as the region 2B becomes narrower in planar view, higher alignment accuracy is required in manufacturing steps such as steps of laminating the respective layers, and the higher-accuracy requirements entail concern about an increase in the number of steps such as inspections and an increase in facility cost.

That is, the battery 1000 is undesirably hard to easily manufacture and insufficient in improvement of reliability. Further, since the region 2A, whose sole through-thickness layer is the solid electrolyte layer 930, is a portion that does not particularly contribute to the basic charge-discharge performance of the battery, it is preferable, from the point of view of improving the volume energy density, that the region 2A be small.

Meanwhile, as mentioned above, the battery 100 includes an electrode layer 10, a counter-electrode layer 20 placed to face the electrode layer 10, and a solid electrolyte layer 30 located between the electrode layer 10 and the counter-electrode layer 20. The electrode layer 10 includes a collector 11, an electrode active material layer 12 located between the collector 11 and the solid electrolyte layer 30, and an insulating layer 60 including, at ends of the power-generating element 50 in planar view, a first insulating film 61 located between the collector 11 and the electrode active material layer 12.

For this reason, even if the collector 11 delaminates at the ends of the collector 11, at which delamination tends to occur, exposure of the collector 11 or the electrode active material layer 12 is reduced, as the first insulating film 61 is present between the collector 11 and the electrode active material layer 12, so that it becomes hard for damage, a short circuit, or other failures to occur due to contact between the collector 11 or the electrode active material layer 12 and another member. Further, in the battery 100, a second insulating film 62 that is continuous with the first insulating film 61 covers the side surfaces of the electrode active material layer 12. Therefore, the corners of the electrode active material layer 12, which are subject to breakage, effectively protected. This brings about improvement in reliability of the battery 100.

Further, in the battery 100, for example, the electrode layer 10, which includes the electrode active material layer 12, is a positive-electrode layer including a positive-electrode active material layer, and the counter-electrode layer 20, which includes the counter-electrode active material layer 22, is a negative-electrode layer including a negative-electrode active material layer. In this case, electrons from the collector 11 do not directly reach a portion of the positive-electrode active material layer (electrode active material layer 12) that is in contact with the first insulating film 61, so that a portion of the positive-electrode active material layer that is in a region 1A shown in FIGS. 1 and 2 hardly functions as an electrode. Meanwhile, a portion of the positive-electrode active material layer that is in a region 1B functions as an electrode. Therefore, in the battery 100, the region 1A hardly functions as a battery, and the region 1B functions as a battery. In the battery 100, although the areas of the positive-electrode active material layer and the negative-electrode active material layer (counter-electrode active material layer 22) in planar view are substantially equal, an effect of reducing the area of the positive-electrode active material layer in planar view is substantially brought about, as the portion of the positive-electrode active material layer that is in the region 1A hardly functions as an electrode. That is, in the battery 100, deposition of metal is suppressed even when the areas of the positive-electrode active material layer and the negative-electrode active material layer in planar view are substantially equal.

Further, since the positive-electrode active material layer and the negative-electrode active material layer are substantially identical in shape and position to each other in planar view and the first insulating film 61 is located between the collector 11 and the positive-electrode active material layer at the ends of the positive-electrode layer (electrode layer 10), a portion of the positive-electrode active material layer placed to face the ends of the negative-electrode active material layer hardly functions as an electrode. As a result, the concentration of electric fields at the ends of the negative-electrode active material layer is suppressed, so that dendrite growth at the ends is inhibited. This brings about improvement in reliability of the battery 100.

Furthermore, at the time of manufacture of the battery 100, it is not necessary to form the positive-electrode active material layer or the negative-electrode active material layer with high position and area accuracy, as the substantive area of the positive-electrode active material layer can be adjusted by the first insulating film 61. This makes it possible to easily manufacture the battery 100. For example, the battery 100 is easily manufactured, for example, by cutting, in a region where a material constituting the insulating layer 60 is located, a laminated body obtained by laminating the positive-electrode layer (electrode layer 10), the solid electrolyte layer 30, and the negative-electrode layer (counter-electrode layer 20).

The first insulating film 61 is not limited to particular positions, provided it is disposed to extend inward from the ends of the power-generating element 50 in planar view. The first insulating film 61 may be located between two adjacent ones of the layers of the power-generating element 50 other than the collector 11 and the electrode active material layer 12. Further, the first insulating film 61 may be embedded in the electrode active material layer 12, the solid electrolyte layer 30, or the counter-electrode active material layer 22. By the insulating layer 60 including the first insulating film 61, which extends inward from the ends of the power-generating element 50 in planar view, and the second insulating film 62, which covers the side surface 51, the power-generating element 50 can be protected from different directions by the first insulating film 61 and the second insulating film 62. Further, by being thinner than the first insulating film 61, the second insulating film 62 makes it hard for an external force to be applied to the second insulating film 62, making it hard for the second insulating film 62 to delaminate from the side surface 51. Further, even in a case where a force that delaminates the second insulating film 62 is applied, delamination hardly propagates to the first insulating film 61, as the second insulating film 62 is thinner. This inhibits the insulating layer 60 as a whole from delaminating. Therefore, the present embodiment makes it possible to enhance the reliability of the battery 100 by effectively protecting the power-generating element 50 with the insulating layer 60.

### Manufacturing Method

The following describes a method for manufacturing a battery according to the present embodiment.

The method for manufacturing a battery according to the present embodiment includes, for example, a laminated body forming step and a cutting step. In the following, the method for manufacturing a battery according to the present embodiment is described with reference to a plurality of examples. However, the method for manufacturing a battery according to the present embodiment is not limited to the following examples.

### (1) Manufacturing Method Example 1

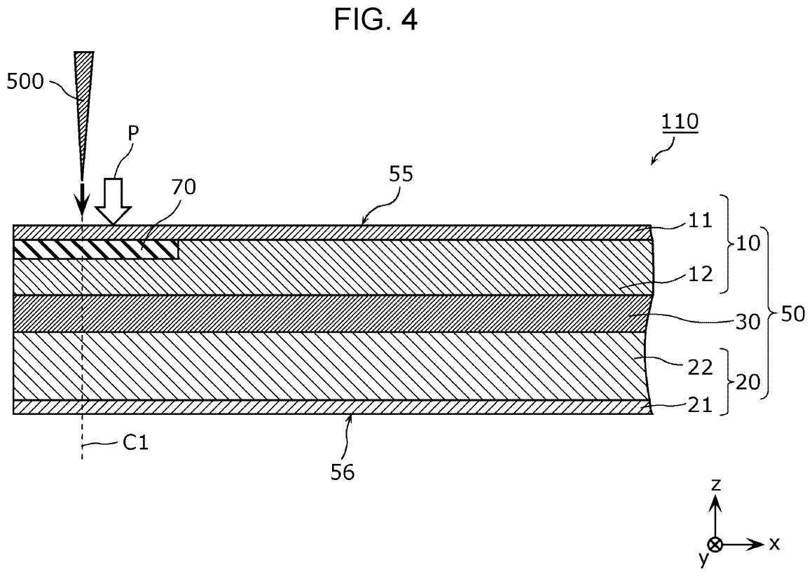

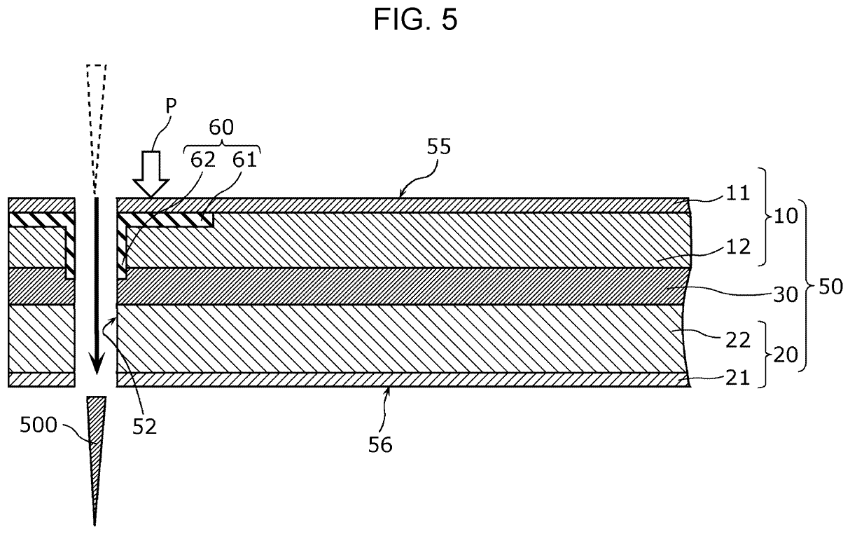

First, Manufacturing Method Example 1 for manufacturing a battery according to the present embodiment is described. FIG. 4 is a cross-sectional view showing an example of a laminated body in Manufacturing Method Example 1 for manufacturing a battery according to the present embodiment. FIG. 5 is a cross-sectional view for explaining a cutting step of Manufacturing Method Example 1 for manufacturing a battery according to the present embodiment. It should be noted that FIGS. 4 and 5 each show a cross-section of part of a laminated body 110.

In the method for manufacturing a battery according to the present embodiment, first, a laminated body forming step is executed. As shown in FIG. 4, in the laminated body forming step, a laminated body 110 including a power-generating element 50 and an insulator 70 placed in a position that overlaps the power-generating element 50 in a planar view of a principal surface 55 of the power-generating element 50 is formed. In the power-generating element 50, an electrode layer 10, a counter-electrode layer 20 placed to face the electrode layer 10, and a solid electrolyte layer 30 located between the electrode layer 10 and the counter-electrode layer 20 are laminated. The laminated body 110 is formed so that an electrode active material layer 12, the solid electrolyte layer 30, and a counter-electrode active material layer 22 are identical in area and position to one another in planar view. In the laminated body 110, the insulator 70 is located between a collector 11 and the electrode active material layer 12. Further, the insulator 70 is disposed on the whole outer periphery of the power-generating element 50 in planar view. That is, the insulator 70 is disposed in the shape of a frame in planar view. It should be noted that the insulator 70 may be disposed on part of the outer periphery of the power-generating element 50 in planar view. Further, the insulator 70 may be in any position that overlaps the power-generating element 50 in planar view, and is placed according to the location of an insulating layer 60 that is formed by the insulator 70.

Specifically, first, the insulator 70 is formed by laminating the insulator 70 on one surface of the collector 11. As a method for forming the insulator 70, there are a variety of possible processes; however, from the point of view of mass-producibility, for example, an application process is used. For example, the insulator 70 is formed by applying a material of the insulator 70 and, when needed, a solvent onto the collector 11 by a high-accuracy coating method such as a gravure roll method or an inkjet method. Further, the material of the insulator 70 may be applied onto the collector 11 after being melted. The insulator 70 is formed in the shape of a layer. The insulator 70 is for example uniform in thickness.

The insulator 70 is constituted by an insulating material that can be fluidized in the after-mentioned cutting step. The insulator 70 is constituted by a thermoplastic material or a curable material such as a thermosetting material or a photocurable material. In a case where the insulator 70 is constituted by the thermoplastic material, the insulator 70 becomes flowable by being heated. Further, in a case where the insulator 70 is constituted by the curable material, the insulator 70 is flowable before a curing process is performed.

The thermoplastic material contains, for example, thermoplastic resin as a major ingredient. Examples of the thermoplastic resin include general-purpose plastics such as polypropylene resin, polyethylene resin, polyethylene terephthalate resin, nylon resin, acrylic resin, polyester resin, and polyimide resin. Further, the thermoplastic resin may be engineering plastic or super-engineering plastic. Further, the thermoplastic material may include a malleable material such as far, wax, or a polysaccharide. Further, the thermoplastic material may contain inorganic particles of a metallic oxide or other materials as additives. The term “major ingredient” as used herein may account for 50% or more of the material, may account for 60% or more of the material, or may account for 70% or more of the material.

The thermosetting material contains, for example, thermosetting resin as a major ingredient. Examples of the thermosetting resin include silicone resin, epoxy resin, acrylic resin, and polyimide resin. The thermosetting material may be a powder or slurry inorganic material that is cured by sintering.

The photocurable material contains, for example, photocurable resin such as ultraviolet curable resin as a major ingredient. Examples of the photocurable resin include silicone resin, epoxy resin, and acrylic resin.

Further, the curable material may contain inorganic particles of a metallic oxide or other materials as additives.

The electrode active material layer 12, the solid electrolyte layer 30, the counter-electrode active material layer 22, and a collector 21 are laminated in this order over the collector 11 with the insulator 70 formed thereon. For example, over a surface of the collector 11 on which the insulator 70 has been formed, the electrode active material layer 12 is laminated so as to cover the insulator 70 in planar view, and the solid electrolyte layer 30, the counter-electrode active material layer 22, and the collector 21 are further laminated in sequence. This results in the formation of the laminated body 110. Furthermore, when needed, a high-pressure press process may be performed on the electrode active material layer 12, the solid electrolyte layer 30, and the counter-electrode active material layer 22.

The electrode active material layer 12, the solid electrolyte layer 30, and the counter-electrode active material layer 22 are each formed, for example, by using a wet coating method. The use of the wet coating method makes it possible to easily laminate each of the layers on the collector 11. Usable examples of the wet coating method include, but are not limited to, coating methods such as a die coating method, a doctor blade method, a roll coater method, a screen printing method, and an inkjet method.

In a case where the wet coating method is used, a paint-making step is executed in which slurries are obtained separately by appropriately mixing together each of the materials that form the electrode active material layer 12, the solid electrolyte layer 30, and the counter-electrode active material layer 22 (i.e. each of the aforementioned materials of the positive-electrode active material layer, the solid electrolyte layer 30, and the negative-electrode active material layer) and a solvent.

As the solvent for use in the paint-making step, a publicly-known solvent that is used in fabricating a publicly-known all-solid battery (e.g., a lithium-ion all-solid battery) may be used.

The slurries, obtained in the paint-making step, of the respective layers are applied over the collector 11 on which the insulator 70 has been formed. This layered coating is executed in the order of the electrode active material layer 12, the solid electrolyte layer 30, and then the counter-electrode active material layer 22. In so doing, the overlaying of a layer being overlaid first may be followed by the overlaying of a next layer, or the overlaying of the next layer may be started during the overlaying of the layer being overlaid first. The slurries of the respective layers are sequentially applied, and after all layers have been applied, a heat treatment that removes the solvents and the binder materials and a high-pressure press process that accelerates the filling of the materials of the respective layers are executed, for example. It should be noted that the heat treatment and the high-pressure press process may be executed each time a layer is overlaid. In the overlaying of the electrode active material layer 12, the solid electrolyte layer 30, and the counter-electrode active material layer 22, the heat treatment and the high-pressure press process may be executed each time one layer is overlaid, may be executed separately after any two layers have been overlaid and after one layer has been overlaid, or may be executed all at once after all three layers have been overlaid. Further, the high-pressure press process involves the use of, for example, a roll press, a flat-plate press, or other presses. It should be noted that at least one of the heat treatment and the high-pressure press process may not be performed.

Performing a layered coating method in this way makes it possible to improve the bondability of the interface between each of the layers and another and reduce interface resistance, and also makes it possible to improve the bondability between the powder materials used in the electrode active material layer 12, the solid electrolyte layer 30, and the counter-electrode active material layer 22 and reduce grain boundary resistivity. That is, favorable interfaces are formed between each of the layers of the power-generating element 50 and another and between each of the powder materials contained in the respective layers and another.

Next, in the method for manufacturing a battery according to the present embodiment, the cutting step is executed. As shown in FIG. 4, in the cutting step, a cutting edge 500 is used to cut the laminated body 110 in a direction across the principal surface 55 of the power-generating element 50 so that the cutting edge 500 passes through the insulator 70. In the example shown in FIG. 4, the laminated body 110 is cut along a direction orthogonal to the principal surface 55 of the power-generating element 50 (i.e., the direction of laminating) at a position C1 that passes through the insulator 70 and where all layers of the power-generating element 50 are cut at once. Further, the position C1 is a position that passes through the principal surfaces 55 and 56 of the power-generating element 50. At the position C1, the collector 11, the insulator 70, the electrode active material layer 12, the solid electrolyte layer 30, and the counter-electrode active material layer 22 are laminated in this order, and they are all cut at once. This makes it unnecessary to laminate the layers of the power-generating element 50 in shapes into which they have been cut, thus making it possible to easily manufacture a battery 100.

Further, as shown in FIG. 5, a cut surface 52 of the power-generating element 50 is formed by cutting the laminated body 110.

Further, the cutting step includes cutting the laminated body 110 while applying the insulator 70 to the cut surface 52 with the cutting edge 500. The insulator 70 deforms along a direction of travel of the cutting edge 500 so as to cover the cut surface 52. For example, when the cut surface 52 is formed at a position that passes through the insulator 70, the insulator 70, which is flowable, leaks out of the cut surface 52 under the load of the cutting edge 50. Then, the leaked insulator 70 adheres to the cutting edge 500 while the cutting edge 500 is moving, and the insulator 70 adhering to the cutting edge 500 is spread over the cut surface 52 while the cut surface 52 is being formed. For example, cutting down the laminated body 110 with the cutting edge 500 from above the insulator 70 causes the insulator 70 to be applied to a part of the cut surface 52 that is formed at a lower level than the insulator 70. Specifically, the cutting edge 500 moves from the electrode layer 10 toward the counter-electrode layer 20, i.e., from top to bottom, of the power-generating element 50, and the insulator 70 is applied by the cutting edge 500 to a part of the cut surface 52 that is located at a lower level than the insulator 70. This results in the formation of an insulating layer 60 including a second insulating film 62 that is a portion of the insulator 70 applied to the cut surface 52 and a first insulating film 61 that is a portion of the insulator 70 that remains between the collector 11 and the electrode active material layer 12. The cut surface 52 serves as a side surface 51 of the battery 100. Through the laminated body forming step and the cutting step, the battery 100 is manufactured.

In the cutting step, the speed of movement of the cutting edge 500 may be constant or may be varied. Further, during the cutting, the movement of the cutting edge 500 may be temporarily stopped. Further, the cutting edge 500 may move in a given direction at the position C1 or may be moved so as to be temporarily put back into place. For example, the cutting edge 500 may reciprocate along the direction of laminating. This makes it possible to apply the insulator 70 to cut surfaces 52 on both sides of the insulator 70 in the direction of laminating.

In a case where the insulator 70 is constituted by a thermoplastic material, the cutting step includes cutting the laminated body 110 after heating at least one of the laminated body 110 and the cutting edge 500 to a temperature that is higher than or equal to a softening point of the insulator 70. This allows the insulator 70 to flow by softening at the time of cutting of the laminated body 110, so that the insulator 70 is applied to the cut surface 52 by the cutting edge 500. Thus, since the insulator 70 can be easily fluidized, the second insulating film 62 can be formed into a stable shape. Further, adjusting the temperature to which the insulator 70 is heated makes it possible to adjust the viscosity of the insulator 70, making it easy to form the second insulating film 62 into a desired shape. The softening point of the insulator 70 is for example a Vicat softening temperature.

The temperature to which the insulator 70 is heated is for example lower than or equal to 300° C., or may be lower than or equal to 250° C., or may be lower than or equal to 200° C. This makes it hard for the materials of the layers of the power-generating element 50 to suffer decomposition, alternation, or other changes in quality, making it possible to reduce deterioration of the power-generating element 50 in the manufacturing process.

Further, the temperature to which the insulator 70 is heated may be varied during the cutting. This makes it possible to adjust the shape and position of the second insulating film 62. For example, lowering the temperature of at least one of the laminated body 110 and the cutting edge 500 during the cutting causes the viscosity of the insulator 70 to rise and makes it hard for the insulator 70 to flow after the lowering of the temperature, stopping the insulator 70 from being applied to the cut surface 52 by the cutting edge 500. Further, in a case where the temperature of at least one of the laminated body 110 and the cutting edge 500 is lowered, the temperature is lowered, for example, after the movement of the cutting edge 500 has been temporarily stopped.

Further, in a case where both the laminated body 110 and the cutting edge 500 are heated, the heating of the laminated body 110 and the cutting edge 500 includes, for example, heating the laminated body 110 to a first temperature and heating the cutting edge 500 to a second temperature that is higher than the first temperature. This causes the cutting edge 500, which applies the insulator 70, to be heated to a higher temperature, thus making it possible to effectively fluidize the insulator 70 near the cut surface 52 and apply the insulator 70 to the cut surface 52.

Further, in a case where the insulator 70 is constituted by a curable material, the insulator 70 is cured by a curing process such as heating or photoirradiation after the laminated body 110 has been laminated. In this way, the insulating layer 60 is formed. Thus, in a case where the insulator 70 is constituted by a curable material, the insulator 70 can be easily applied to the cut surface 52 without heating or other processes during the cutting of the laminated body 110. This makes it possible to reduce deterioration of the materials of the layers of the power-generating element 50 by heat and simplify cutting equipment. Further, adjusting the viscosity of the curable material before curing makes it easy to form the second insulating film 62 into a desired shape.

Further, as shown in FIGS. 4 and 5, the cutting step may include cutting the laminated body 110 while applying a pressure P to the laminated body 110 in the direction of laminating. The pressure P is for example applied to a position that overlaps the insulator 70 in planar view. The pressure P may be applied to the whole of the laminated body 110. The insulator 70 leaks out of the cut surface 52 under the load of the cutting edge 500 alone; however, by thus cutting the laminated body 110 while applying the pressure P, the insulator 70 is pushed out toward the cut surface 52, so that it becomes easy for the insulator 70 to adhere to the cutting edge 500. This makes it possible to stably apply the insulator 70 to the cut surface 52. Further, adjusting the pressure P makes it possible to adjust an amount of the insulator 70 that is pushed out toward the cut surface 52, thus making it easy to form the second insulating film 62 into a desired shape.

Further, the cut surface 52 formed by the cutting step may be further covered with a sealing member or other members.

As noted above, the method for manufacturing a battery according to the present embodiment includes cutting the laminated body 110 while applying the insulator 70 to the cut surface 52 with the cutting edge 500. Thus, simply by cutting the laminated body 110 with the cutting edge 500, the second insulating film 62 is formed by the insulator 70 being applied to the cut surface 52, and the first insulating film 61, which remains between the collector 11 and the electrode active material layer 12, is formed. This makes it possible to easily manufacture a battery 100 including an insulating layer 60 including a first insulating film 61 and a second insulating film 62. Further, the second insulating film 62 can be easily formed into a thinner shape than the first insulating film 61, as the second insulating film 62 is formed by being applied to the cut surface 52 by the cutting edge 500. Therefore, the method for manufacturing a battery according to the present embodiment makes it possible to manufacture a highly reliable battery 100 in a simple way.

Further, the cutting step includes cutting the laminated body 110 at one time at a position C1 that passes through the insulator 70. This makes it unnecessary to laminate the layers of the power-generating element 50 in shapes into which they have been cut, thus making it possible to manufacture a battery 100 with high production efficiency. Further, this makes it possible to manufacture a battery 100 with the insulating layer 60 formed at ends of the power-generating element 50. The insulating layer 60 causes the power-generating element 50 to be protected by covering a side surface 51 at the ends of the power-generating element 50, at which the layers tend to delaminate. This makes it possible to manufacture a highly reliable battery 100.

Further, the dimensions of the first insulating film 61 can be determined simply by adjusting the cutting position. Therefore, although the presence of the first insulating film 61 inhibits the electrode active material layer 12 and the collector 11 from giving and receiving electrons to and from each other and results in the formation of a region where the electrode active material layer 12 hardly functions as an electrode, the region can be minimized by adjusting the dimensions of the first insulating film 61. This makes it possible to easily manufacture a battery 100 with a high volume energy density.

Further, in a case where the electrode active material layer 12 is a positive-electrode active material layer and the counter-electrode active material layer 22 is a negative-electrode active material layer, the formation of the first insulating film 61 at the ends of the collector 11 prevents electrons from the collector 11 from reaching ends of the positive-electrode active material layer (electrode active material layer 12), so that the function of the positive-electrode active material layer as an electrode at the ends is inhibited. That is, the substantive area of the positive-electrode active material layer in planar view is reduced. Further, since the power-generating element 50 is cut along the direction of laminating, the positive-electrode active material layer and the negative-electrode active material layer (counter-electrode active material layer 22) are substantially identical in shape and position to each other in planar view, and are also substantially identical in area to each other. This causes the positive-electrode active material layer to become narrower in substantive area (area that functions as an electrode) than the negative-electrode active material layer and be located within the negative-electrode active material layer in planar view. This results in suppression of deposition of metal on the negative-electrode active material layer as mentioned above. This brings about further improvement in reliability of the battery 100 to be manufactured.

In the absence of the first insulating film 61, the electrode active material layer 12 is laminated at the ends of the collector 11 too. Therefore, even when the laminated body 110 is cut at one time, a battery is manufactured in which exposure of the electrode active material layer 12 cannot be reduced when the ends of the collector 11 delaminate and in which there is no substantive difference in area between the electrode active material layer 12 and the counter-electrode active material layer 22. Therefore, although a battery can be easily manufactured, such a battery is low in reliability, and it is hard to employ such a manufacturing method. On the other hand, in the manufacturing method according to the present embodiment, as mentioned above, the laminated body 110 is cut at one time at the position C1 the passes through the insulator 70. This makes it possible to, in addition to easily manufacturing a battery 100, reduce exposure of the electrode active material layer 12, reduce the area of the electrode active material layer 12 that functions as an electrode, and adjust the area of the first insulating film 61. This makes it possible to easily manufacture a highly reliable battery 100 with a high volume energy density.

Although the foregoing has described the formation of one cut surface 52 in the cutting step, a plurality of cut surfaces may be formed in a manner similar to that described above. For example, all side surfaces of the power-generating element 50 are formed by the aforementioned cutting step.

### (2) Manufacturing Method Example 2

Next, Manufacturing Method Example 2 for manufacturing a battery according to the present embodiment is described. The following describes Manufacturing Method Example 2 with a focus on differences from Manufacturing Method Example 1, and omits or simplifies a description of common features.

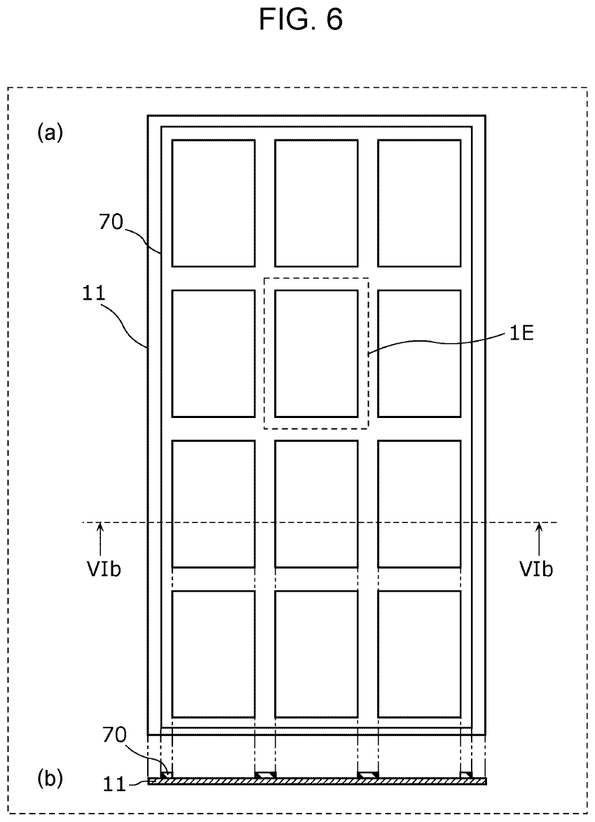

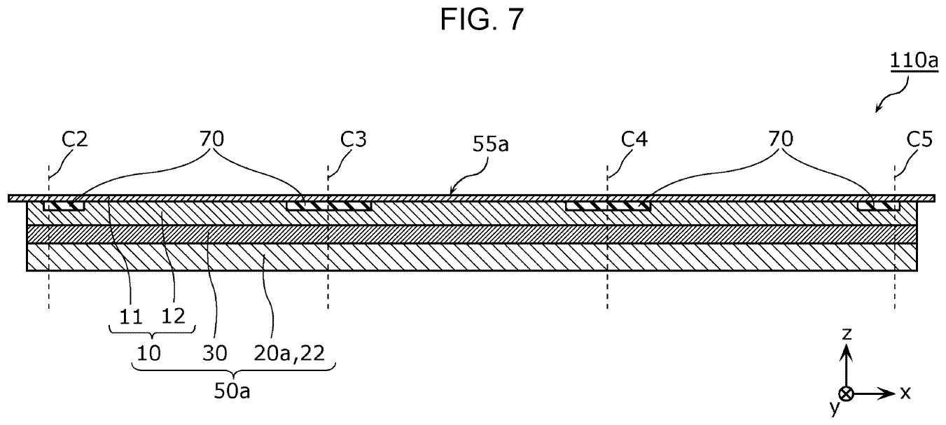

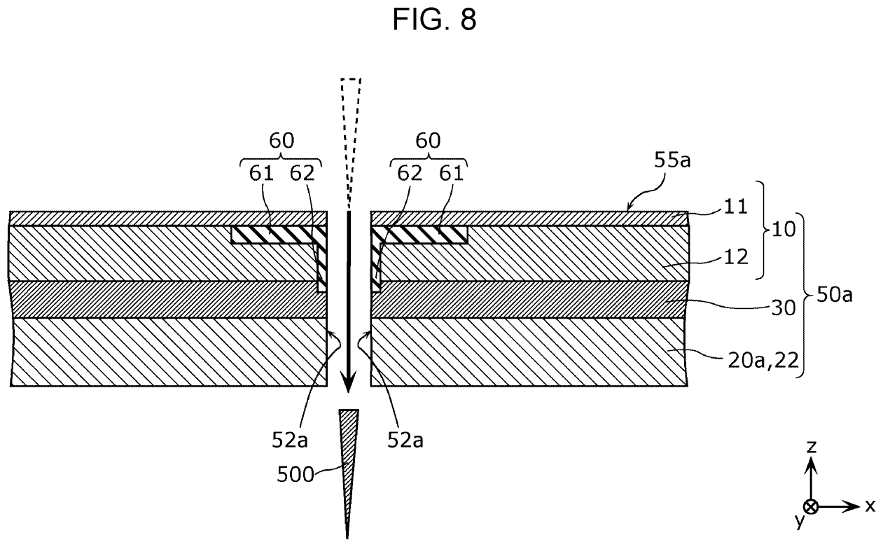

FIG. 6 illustrates a top view and a cross-sectional view showing an example of a collector 11 with an insulator 70 formed thereon in Manufacturing Method Example 2 for manufacturing a battery according to the present embodiment. Specifically, (a) of FIG. 6 is a top view showing the collector 11 with the insulator 70 formed thereon. (b) of FIG. 6 is a cross-sectional view taken along line VIb-VIb in (a) of FIG. 6. FIG. 7 is a cross-sectional view showing an example of a laminated body in Manufacturing Method Example 2 for manufacturing a battery according to the present embodiment. FIG. 8 is a cross-sectional view for explaining a cutting step of Manufacturing Method Example 2 for manufacturing a battery according to the present embodiment. It should be noted that FIG. 8 shows a cross-section of part of a laminated body 110a.

In a laminated body forming step, for example, as shown in FIG. 6, the insulator 70 is formed in a predetermined planimetric shape on top of the collector 11. Although, in the example shown in FIG. 6, the predetermined planimetric shape is a grid shape, it may be another shape such as a striped shape. Further, although, in FIG. 6, the predetermined planimetric shape is a grid shape including squares or rectangles of the same size, it may be a grid shape including squares or rectangles of different sizes. Further, even in a case where the predetermined planimetric shape is a striped shape, the stripes may all be placed at regular spacings, or some of the stripes may be placed at different spacings. Further, in the cutting step, the insulator 70 is divided along a direction parallel with the length of the insulator 70 to cover the cut surface. This makes it possible to easily form a battery 100 having an insulating layer 60 formed along ends of a power-generating element 50 in planar view. In FIG. 6, the rectangular region 1E, which is indicated by dashed lines, is equivalent to the size of one battery 100.

By the insulator 70 thus being laminated in a predetermined planimetric shape such as a grid shape and divided along a direction parallel with the length of the insulator 70 in the cutting step, a plurality of batteries 100 of the same shape or different shapes can be simultaneously manufactured. This brings about improvement in efficiency in the manufacture of batteries 100.

The insulator 70 shown in FIG. 6 is formed, for example, by applying a material of the insulator 70 onto the collector 11 in a continuous process such as a roll-to-roll process. It should be noted that the formation of the insulator 70 is not limited to a continuous process such as a roll-to-roll process, but may be a batch process for forming the insulator 70 for each single collector 11.

Next, as shown in FIG. 7, an electrode active material layer 12, a solid electrolyte layer 30, and a counter-electrode active material layer 22 are laminated in this order over the collector 11 on which the insulator 70 has been formed in the predetermined planimetric shape. For example, on top of the collector 11 on which the insulator 70 has been formed, the electrode active material layer 12 is laminated so as to cover the insulator 70 in planar view, and the solid electrolyte layer 30 and the counter-electrode active material layer 22 are further laminated in sequence. This results in the formation of a laminated body 110a including a power-generating element 50a. The power-generating element 50a includes an electrode layer 10, the solid electrolyte layer 30, and a counter-electrode layer 20a. The laminated body 110a is formed such that the electrode active material layer 12, the solid electrolyte layer 30, and the counter-electrode active material layer 22 are identical in area and position to one another in planar view. Further, in the laminated body 110a, one principal surface of the counter-electrode active material layer 22 is exposed, and only the counter-electrode active material layer 22 is laminated as the counter-electrode layer 20a. Further, the insulator 70 is located between the collector 11 and the electrode active material layer 12.

It should be noted that the structure of the laminated body 110a is not limited to the example shown in FIG. 7. In the laminated body 110a, as in the case of Manufacturing Method Example 1, a collector 21 may be further laminated on the counter-electrode active material layer 22. Further, the electrode active material layer 12, the solid electrolyte layer 30, and the counter-electrode active material layer 22 may be different in area and position from one another in planar view. Further, the insulator 70 may be in any position that overlaps the power-generating element 50a in planar view, and is placed according to the location of an insulating layer 60 that is formed by the insulator 70.

Further, the formation of the insulator 70 and the formation of the electrode active material layer 12, the solid electrolyte layer 30, and the counter-electrode active material layer 22 may be performed in a series of continuous processes such as roll-to-roll processes.

Next, in the cutting step, as shown in FIGS. 7 and 8, a cutting edge 500 is used to cut the laminated body 110a in a direction across a principal surface 55a of the power-generating element 50a so that the cutting edge 500 passes through the insulator 70. In the example shown in FIG. 7, the laminated body 110a is cut along a direction orthogonal to the principal surface 55a of the power-generating element 50a at positions C2 to C5 that pass through the insulator 70 and where all layers of the power-generating element 50a are cut at once. Further, the insulator 70 is divided by the cutting edge 500.

In a case where the insulator 70 is formed in a planimetric shape such as a grid shape having an elongated portion as shown in FIG. 6 in planar view, the power-generating element 50a is cut at one time along a direction parallel with the length of the insulator 70. This gives batteries 100 having the insulating layer 60 located at all ends facing cut surfaces of the batteries 100 thus manufactured.

Further, as shown in FIG. 8, a cut surface 52a of the power-generating element 50a is formed by cutting the laminated body 110a. FIG. 8 is an enlarged view of the position C3 of the laminated body 110a and an area therearound.

Further, as in Manufacturing Method Example 1, the cutting step includes cutting the laminated body 110a while applying the insulator 70 to the cut surface 52a with the cutting edge 500. This results in the formation of an insulating layer 60 including a second insulating film 62 that is a portion of the insulator 70 applied to the cut surface 52a and a first insulating film 61 that is a portion of the insulator 70 that remains between the collector 11 and the electrode active material layer 12. Further, the cut surface 52a serves as part of the side surface 51 of a battery 100.

In Manufacturing Method Example 2, by cutting the laminated body 110 at the position where the insulator 70 is divided, cut surfaces 52a coated with second insulating films 62 can be formed on both sides of the cutting position.

In Manufacturing Method Example 2, after the cutting step, the collector 21 is laminated as an additional collector on a surface of the power-generating element 50a thus cut that faces away from the collector 11 (i.e., a surface of the power-generating element 50a perpendicular to the direction of laminating on which the collector 11 is not laminated). This gives a battery 100.

### (3) Manufacturing Method Example 3

Next, Manufacturing Method Example 3 for manufacturing a battery according to the present embodiment is described. The following describes Manufacturing Method Example 3 with a focus on differences from Manufacturing Method Example 1, and omits or simplifies a description of common features.

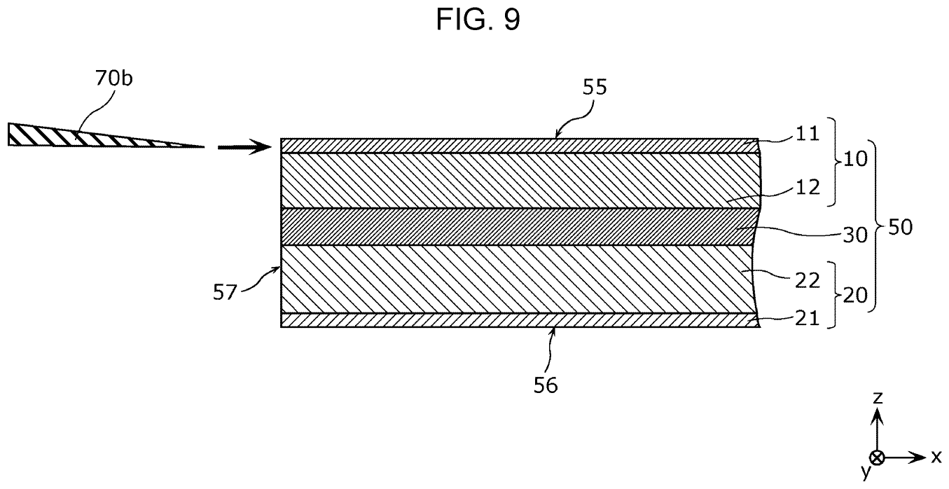

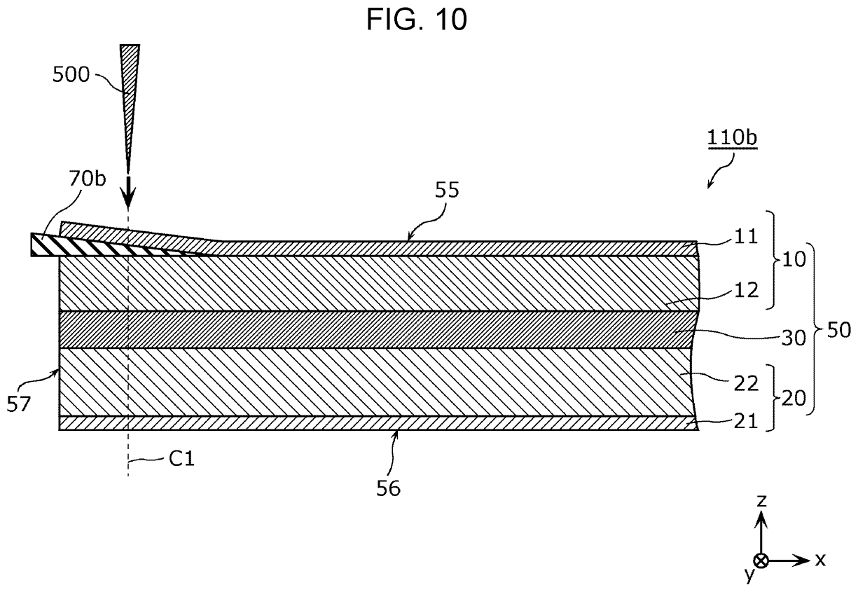

FIG. 9 is a cross-sectional view for explaining a laminated body forming step of Manufacturing Method Example 3 for manufacturing a battery according to the present embodiment. FIG. 10 is a cross-sectional view showing an example of a laminated body in Manufacturing Method Example 3 for manufacturing a battery according to the present embodiment. It should be noted that FIG. 9 shows a cross-section of part of a power-generating element 50. Further, FIG. 10 shows a cross-section of part of a laminated body 110b.

In the laminated body forming step of Manufacturing Method Example 3, as shown in FIG. 9, first, a power-generating element 50 is prepared. The power-generating element 50 is fabricated, for example, by forming layers of the power-generating element 50 by overlaying without forming an insulator 70 in a method for forming a laminated body 110 in Manufacturing Method Example 1.

Next, an insulator 70b is inserted into a side surface 57 of the power-generating element 50 before the power-generating element 50 is cut. For example, the insulator 70b is inserted into the interface between the collector 11 and the electrode active material layer 12 on the side surface 57. This results in the formation of a laminated body 110b shown in FIG. 10. This makes it possible to form the laminated body 110b simply by inserting the insulator 70b into the side surface 57 after the layers of the power-generating element 50 have been laminated. Further, the position of an insulating layer 60 that is formed from the insulator 70b can be adjusted according to the position of insertion of the insulator 70b. It should be noted that the position of insertion of the insulator 70b is not limited to the aforementioned example, but the insulator 70b may be inserted into any place on the side surface 57.

The insulator 70b is constituted by a thermoplastic material cited as an example of a material by which the aforementioned insulator 70 is constituted.

Next, in a cutting step, a cutting edge 500 is used to cut the laminated body 110b in a direction across a principal surface 55 of the power-generating element 50 so that the cutting edge 500 passes through the insulator 70b. A detailed description of the cutting step is omitted, as the cutting step is similar to that of Manufacturing Method Example 1.

### (4) Manufacturing Method Example 4

Next, Manufacturing Method Example 4 for manufacturing a battery according to the present embodiment is described. The following describes Manufacturing Method Example 4 with a focus on differences from Manufacturing Method Example 1, and omits or simplifies a description of common features.

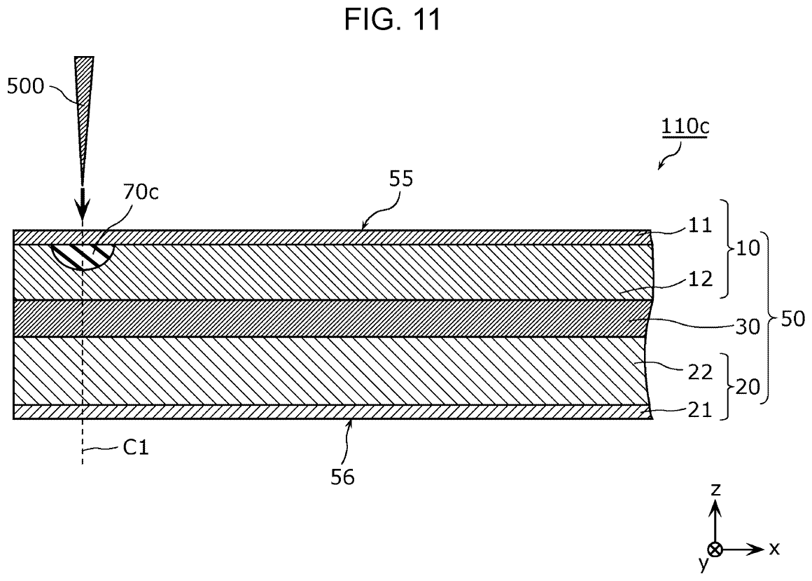

FIG. 11 is a cross-sectional view showing an example of a laminated body in Manufacturing Method Example 4 for manufacturing a battery according to the present embodiment. It should be noted that FIG. 11 shows a cross-section of part of a laminated body 110c.

In a laminated body forming step, as shown in FIG. 11, the laminated body 110c is formed. The laminated body 110 differs from the laminated body 110 in Manufacturing Method Example 1 in that the laminated body 110c includes an insulator 70c instead of the insulator 70. The insulator 70c is semicircular in cross-section. Therefore, the insulator 70c is not uniform in thickness, and a central part of the insulator 70c is thicker than an end of the insulator 70c.

Next, in a cutting step, a cutting edge 500 is used to cut the laminated body 110c in a direction across a principal surface 55 of a power-generating element 50 so that the cutting edge 500 passes through the insulator 70c. In the example shown in FIG. 11, the cutting position C1 passes through the central part, i.e., the thickest part, of the insulator 70c. It should be noted that the position C1 may pass through part of the insulator 70c other than the central part, provided it is a position that passes through the insulator 70c. A detailed description of the cutting step is omitted, as the cutting step is similar to that of Manufacturing Method Example 1.

### Modifications

The following describes modifications of Embodiment 1. The following describes the modifications with a focus on differences from the embodiment and between the modifications, and omits or simplifies a description of common features.

### (1) Modification 1

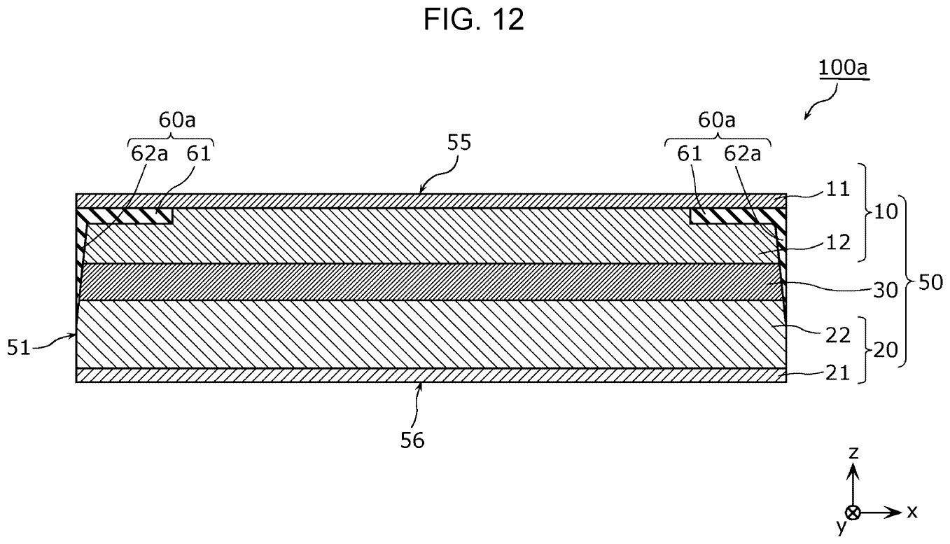

First, Modification 1 of Embodiment 1 is described. FIG. 12 is a cross-sectional view showing an example of a battery according to the present modification. As shown in FIG. 12, the battery 100a according to the present modification differs from the battery 100 according to Embodiment 1 in that the battery 100a includes an insulating layer 60a instead of the insulating layer 60.

The insulating layer 60a includes a first insulating film 61 and a second insulating film 62a.

The second insulating film 62a is continuous with the first insulating film 61 and covers the side surface 51 of the power-generating element 50. This causes the side surface 51 to be protected by the second insulating film 62a.

The second insulating film 62a covers a region of the side surface 51.

Specifically, the second insulating film 62a covers the electrode active material layer 12, the solid electrolyte layer 30, and the counter-electrode active material layer 22 on the side surface 51. The second insulating film 62a continuously covers an area from the electrode active material layer 12 to part of the counter-electrode active material layer 22 on the side surface 51.

The second insulating film 62a is thinner than the first insulating film 61. This thickness of the second insulating film 62a becomes smaller away from the first insulating film 61 along the side surface 51. This reduces the thickness of an end of the second insulating film 62a at which delamination tends to start and that is away from the first insulating film 61, thus making it harder for the second insulating film 62a to delaminate from the side surface 51. This makes it possible to enhance the reliability of the battery 100a.

The second insulating film 62a is formed, for example, in the aforementioned cutting step by adjusting cutting conditions such as the speed of movement or temperature of the cutting edge 500 and performing cutting under such conditions that the insulator 70 is more easily applied in earlier phase of the cutting. For example, as the speed of movement of the cutting edge 500 becomes higher, the thickness of the second insulating film 62a tends to become smaller away from the first insulating film 61 along the side surface 51. Further, the thickness of the second insulating film 62a may be adjusted by varying the pressure P during the cutting.

### (2) Modification 2

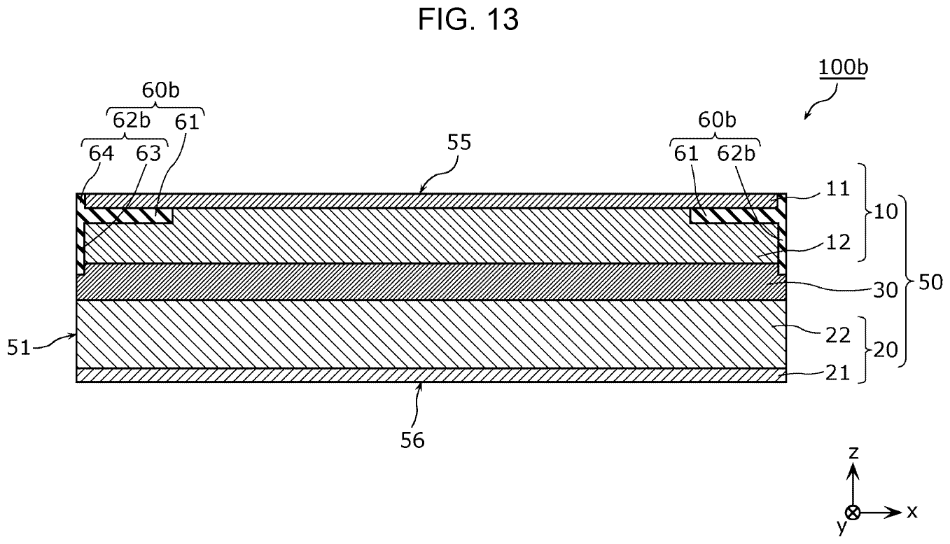

Next, Modification 2 of Embodiment 1 is described. FIG. 13 is a cross-sectional view showing an example of a battery according to the present modification. As shown in FIG. 13, the battery 100b according to the present modification differs from the battery 100 according to Embodiment 1 in that the battery 100b includes an insulating layer 60b instead of the insulating layer 60.

The insulating layer 60b includes a first insulating film 61 and a second insulating film 62b. The second insulating film 62b includes a first portion 63 and a second portion 64 that are continuous with the first insulating film 61 and that cover the side surface 51 of the power-generating element 50. This causes the side surface 51 to be protected by the second insulating film 62b.

The first portion 63 extends in a first direction along the side surface 51 from the ends of the first insulating film 61. The first direction is for example a direction perpendicular to the principal surface 55 that is from the electrode layer 10 toward the counter-electrode layer 20. The first portion 63 covers the electrode active material layer 12 and the solid electrolyte layer 30 on the side surface 51.

The second portion 64 extends in a second direction opposite to the first direction along the side surface 51 from the ends of the first insulating film 61. The second direction is for example a direction perpendicular to the principal surface 55 that is from the counter-electrode layer 20 toward the electrode layer 10. The second portion 64 covers the collector 11 on the side surface 51.

The first portion 63 and the second portion 64 are each thinner than the first insulating film 61. The first portion 63 and the second portion 64 may be equal or different in thickness to or from each other.

By the second insulating film 62b thus including the first portion 63 and the second portion 64, the respective side surfaces of the collector 11 and the electrode active material layer 12 located on both sides in the direction of laminating across the first insulating film 61 are covered with the second insulating film 62b. Thus, the second insulating film 62b makes it hard for the collector 11 and the electrode active material layer 12 to delaminate. This makes it possible to enhance the reliability of the battery 100b.

The second insulating film 62b is formed by applying the insulator 70 to the cut surface 52 with the cutting edge 500 by causing the cutting edge 500 to reciprocate along the direction of laminating in the aforementioned cutting step.

In Modifications 1 and 2, as in the case of Embodiment 1, the first insulating film 61 is not limited to particular positions, provided it is disposed to extend inward from the ends of the power-generating element 50 in planar view. The first insulating film 61 may be located between two adjacent ones of the layers of the power-generating element 50 other than the collector 11 and the electrode active material layer 12. Further, the first insulating film 61 may be embedded in the electrode active material layer 12, the solid electrolyte layer 30, or the counter-electrode active material layer 22.

### (3) Modification 3

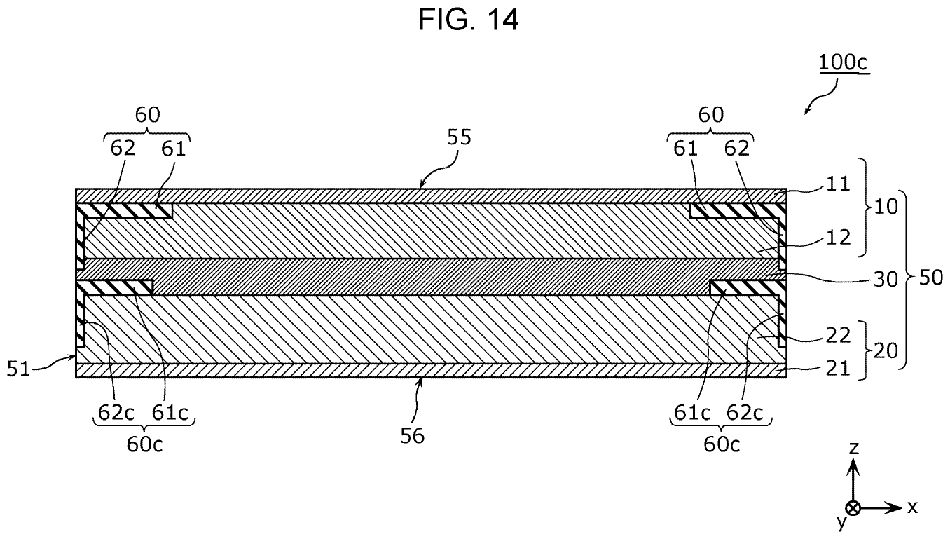

Next, Modification 3 of Embodiment 1 is described. FIG. 14 is a cross-sectional view showing an example of a battery according to the present modification. As shown in FIG. 14, the battery 100c according to the present modification differs in configuration from the battery 100 according to Embodiment 1 in that the battery 100c further includes an insulating layer 60c.

The insulating layer 60c includes a first insulating film 61c and a second insulating film 62c. The second insulating film 62c is thinner than the first insulating film 61c. The insulating film 60c may be constituted, for example, by a material that is identical to that of the insulating layer 60, but may be constituted by a material that is different from that of the insulating layer 60. In FIG. 14, the insulating layer 60 and the insulating 60c are separate from each other. However, the second insulating film 62 may extend further downward so that the insulating layer 60 and the insulating layer 60c are continuous with each other.

The first insulating film 61c is positioned to extend inward from ends of the power-generating element 50 in a planar view of the principal surface 55. The first insulating film 61c extends inward from the ends of the power-generating element 50, for example, along a direction parallel with the principal surface 55. A thickness direction of the first insulating film 61c corresponds to a direction normal to the principal surface 55. The first insulating film 61c overlaps the power-generating element 50 in planar view.

The first insulating film 61c is located between the solid electrolyte layer 30 and the counter-electrode active material layer 22. A lower surface of the first insulating film 61c is in contact with the counter-electrode active material layer 22. The first insulating film 61c is in contact with the counter-electrode active material layer 22 at ends of the counter-electrode layer 20 in planar view. An upper surface of the first insulating film 61c is in contact with the solid electrolyte layer 30. Further, the first insulating film 61c overlaps the electrode active material layer 12 in planar view.

The first insulating film 61c overlaps the first insulating film 61 in planar view. Inner ends of the first insulating film 61c are located further outward than inner ends of the first insulating film 61 in planar view. As mentioned above, the first insulating film 61 reduces the area of the electrode active material layer 12 that functions as a battery. Further, the counter-electrode active material layer 22 is blocked by the first insulating film 61c, which is in contact with the counter-electrode active material layer 22, from giving and receiving ions to and from the solid electrolyte layer 30, so that the area of the counter-electrode active material layer 22 that functions as a battery is reduced. Since the inner ends of the first insulating film 61c are located further outward than the inner ends of the first insulating film 61 in planar view, the area of the electrode active material layer 12 that functions as a battery is smaller than the area of the counter-electrode active material layer 22 that functions as a battery. Therefore, in a case where the electrode layer 10 is a positive-electrode layer and the counter-electrode layer 20 is a negative-electrode layer, an effect that is similar to the effect described in Embodiment 1 of reducing the area of the electrode active material layer 12 is brought about.

The second insulating film 62c covers the side surface 51 of the power-generating element 50 and is continuous with ends of the first insulating film 61c. The second insulating film 62c is continuous with the ends of the first insulating film 61c on the outer periphery of the power-generating element 50 in planar view. The second insulating film 62c extends toward the counter-electrode layer 20 along the side surface 51 from the ends of the first insulating film 61c. This causes the side surface 51 to be protected by the second insulating film 62c.

The second insulating film 62c covers a region of the side surface 51. Specifically, the second insulating film 62c covers part of the counter-electrode active material layer 22 on the side surface 51. It should be noted that a region on the side surface 51 that the second insulating film 62c covers is not limited to a particular region. The second insulating film 62c may cover the whole of the counter-electrode active material layer 22 on the side surface 51. Further, the second insulating film 62c may further cover the collector 21 on the side surface 51.

Since the battery 100c further includes the insulating layer 60c as well as the insulating layer 60, a plurality of places in the battery 100c can be covered with the insulating layer 60 and the insulating layer 60c. This makes it possible to further enhance the reliability of the battery 100c.

The battery 100c is formed, for example, in the aforementioned cutting step by cutting a laminated body having an insulator 70 placed in positions corresponding to the insulating layer 60 and the insulating layer 60c. Specifically, first, in the laminated body forming step, a laminated body is formed in which the insulator 70 is placed between the collector 11 and the electrode active material layer 12 and between the solid electrolyte layer 30 and the counter-electrode active material layer 22. Next, the battery 100c is obtained by cutting the laminated body in the cutting step.

The first insulating film 61c is not limited to particular positions, provided it is disposed to extend inward from the ends of the power-generating element 50 in planar view. The first insulating film 61c may be located between two adjacent ones of the layers of the power-generating element 50 other than the solid electrolyte layer 30 and the counter-electrode active material layer 22. Further, the first insulating film 61c may be embedded in the electrode active material layer 12, the solid electrolyte layer 30, or the counter-electrode active material layer 22.

### (4) Modification 4

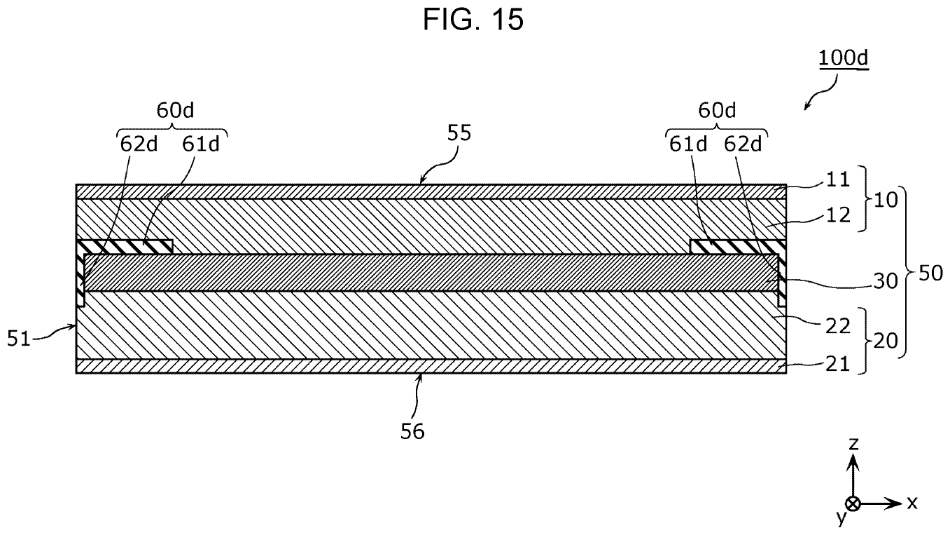

Next, Modification 4 of Embodiment 1 is described. FIG. 15 is a cross-sectional view showing an example of a battery according to the present modification. As shown in FIG. 15, the battery 100d according to the present modification differs from the battery 100 according to Embodiment 1 in that the battery 100d includes an insulating layer 60d instead of the insulating layer 60.

The insulating layer 60d includes a first insulating film 61d and a second insulating film 62d. The second insulating film 62d is thinner than the first insulating film 61d.

The first insulating film 61d is positioned to extend inward from ends of the power-generating element 50 in a planar view of the principal surface 55. The first insulating film 61d extends inward from the ends of the power-generating element 50, for example, along a direction parallel with the principal surface 55. The first insulating film 61d overlaps the power-generating element 50 in planar view.

Further, the first insulating film 61d is located between the electrode active material layer 12 and the solid electrolyte layer 30. An upper surface of the first insulating film 61d and an inner side surface of the first insulating film 61d in planar view are in contact with the electrode active material layer 12. The first insulating film 61d is in contact with the electrode active material layer 12 at the ends of the electrode layer 10 in planar view. The lower surface of the first insulating film 61d is in contact with the solid electrolyte layer 30. Further, the first insulating film 61d overlaps the counter-electrode active material layer 22 in planar view. The placement of the first insulating film 61d between the electrode active material layer 12 and the solid electrolyte layer 30 allows the first insulating film 61d to enter a gap between materials that constitute the electrode active material layer 12 and the solid electrolyte layer 30, making it hard for the electrode active material layer 12 and the solid electrolyte layer 30 to delaminate.

The electrode active material layer 12 is blocked by the first insulating film 61d, which is in contact with the electrode active material layer 12, from giving and receiving ions to and from the solid electrolyte layer 30, so that the area of the electrode active material layer 12 that functions as a battery is reduced. Therefore, the area of the electrode active material layer 12 that functions as a battery is smaller than the area of the counter-electrode active material layer 22 that functions as a battery. Therefore, in a case where the electrode layer 10 is a positive-electrode layer and the counter-electrode layer 20 is a negative-electrode layer, an effect that is similar to the effect described in Embodiment 1 of reducing the area of the electrode active material layer 12 is brought about.

The second insulating film 62d covers the side surface 51 of the power-generating element 50 and is continuous with ends of the first insulating film 61d. The second insulating film 62d is continuous with the ends of the first insulating film 61d on the outer periphery of the power-generating element 50 in planar view. The second insulating film 62d extends toward the counter-electrode layer 20 along the side surface 51 from the ends of the first insulating film 61d. This causes the side surface 51 to be protected by the second insulating film 62d.

The second insulating film 62d covers a region of the side surface 51. Specifically, the second insulating film 62d covers the solid electrolyte layer 30 and the counter-electrode active material layer 22 on the side surface 51. The second insulating film 62d continuously covers an area from the solid electrolyte layer 30 to part of the counter-electrode active material layer 22 on the side surface 51. It should be noted that a region on the side surface 51 that the second insulating film 62d covers is not limited to a particular region. The second insulating film 62d may cover the whole of the counter-electrode active material layer 22 on the side surface 51. Further, the second insulating film 62d may further cover the collector 21 on the side surface 51. Further, the second insulating film 62d may extend toward the electrode layer 10 along the side surface 51 from the ends of the first insulating film 61d to cover the electrode active material layer 12.

The battery 100d is formed, for example, in the aforementioned cutting step by cutting a laminated body having an insulator 70 placed in a position corresponding to the insulating layer 60d. Specifically, first, in the laminated body forming step, a laminated body is formed in which the insulator 70 is placed between the electrode active material layer 12 and the solid electrolyte layer 30. Next, the battery 100d is obtained by cutting the laminated body in the cutting step.

### (5) Modification 5

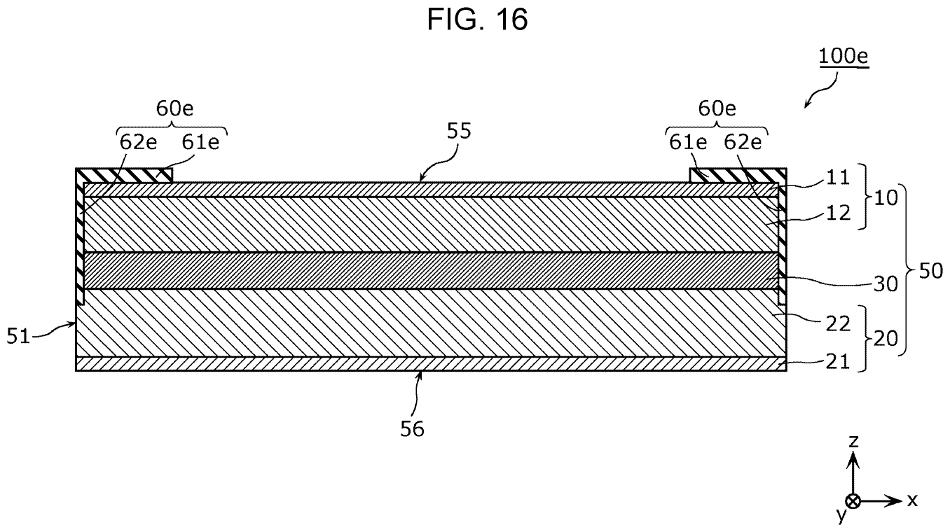

Next, Modification 5 of Embodiment 1 is described. FIG. 16 is a cross-sectional view showing an example of a battery according to the present modification. As shown in FIG. 16, the battery 100e according to the present modification differs from the battery 100 according to Embodiment 1 in that the battery 100e includes an insulating layer 60e instead of the insulating layer 60.

The insulating layer 60e includes a first insulating film 61e and a second insulating film 62e. The second insulating film 62e is thinner than the first insulating film 61e.

The first insulating film 61e is positioned to extend inward from ends of the power-generating element 50 in a planar view of the principal surface 55. The first insulating film 61e extends inward from the ends of the power-generating element 50, for example, along a direction parallel with the principal surface 55. The first insulating film 61e overlaps the power-generating element 50 in planar view.

Further, the first insulating film 61e faces the electrode active material layer 12 across the collector 11. A lower surface of the first insulating film 61e is in contact with the collector 11. The first insulating film 61e is in contact with the collector 11 at ends of the electrode layers 10 in planar view. Therefore, the first insulating film 61e covers part of the principal surface 55. The first insulating film 61e may cover the whole of the principal surface 55.

The second insulating film 62e covers the side surface 51 of the power-generating element 50 and is continuous with ends of the first insulating film 61e. The second insulating film 62e is continuous with the ends of the first insulating film 61e on the outer periphery of the power-generating element 50 in planar view. The second insulating film 62e extends downward along the side surface 51 from the ends of the first insulating film 61e. This causes the side surface 51 to be protected by the second insulating film 62e.

The second insulating film 62e covers a region of the side surface 51. Specifically, the second insulating film 62e covers the collector 11, the electrode active material layer 12, the solid electrolyte layer 30, and the counter-electrode active material layer 22 on the side surface 51. Since the second insulating film 62e covers the whole of the electrode layer 10 along the direction of laminating on the side surface 51, thus making it possible to reduce the risk of a short circuit in the electrode layer 10. The second insulating film 62e continuously covers an area from the collector 11 to part of the counter-electrode active material layer 22 on the side surface 51. It should be noted that a region on the side surface 51 that the second insulating film 62e covers is not limited to a particular region. The second insulating film 62e may cover the whole of the counter-electrode active material layer 22 on the side surface 51. Further, the second insulating film 62e may further cover the collector 21 on the side surface 51. Further, the second insulating film 62e may not cover at least one of the electrode active material layer 12, the solid electrolyte layer 30, and the counter-electrode active material layer 22.

Thus, the insulating layer 60e continuously covers an area from the power-generating element 50 from the principal surface 55 to the side surface 51. This causes a principal surface and a side surface of the collector 11 to be continuously covered by the insulating layer 60e at the ends of the collector 11, at which delamination tends to occur, making it hard for the collector 11 to delaminate.

The battery 100e is formed, for example, in the aforementioned cutting step by cutting a laminated body having an insulator 70 placed in a position corresponding to the insulating layer 60e. Specifically, first, in the laminated body forming step, a laminated body is formed in which the insulator 70 is positioned to face the electrode active material layer 12 across the collector 11, i.e., disposed on top of the principal surface 55. Next, the battery 100e is obtained by cutting the laminated body in the cutting step.

### EMBODIMENT 2

The following describes a battery according to Embodiment 2. The battery according to Embodiment 2 is a laminated battery in which single cells are laminated. Therefore, the battery according to Embodiment 2 includes a plurality of power-generating elements. The following gives a description with a focus on differences from Embodiment 1 described above, and omits or simplifies a description of common features.

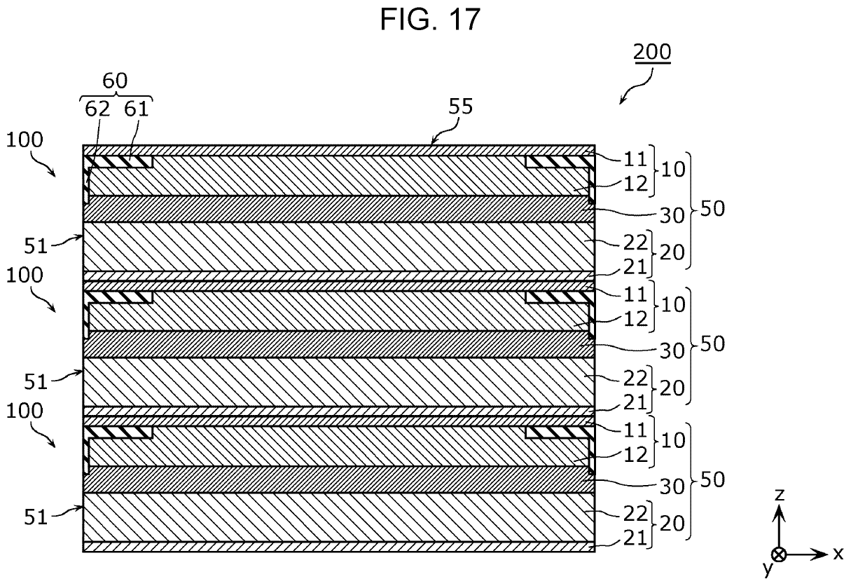

FIG. 17 is a cross-sectional view showing an example of a battery according to the present embodiment. As shown in FIG. 17, the battery 200 according to the present embodiment includes a plurality of power-generating elements 50 and a plurality of insulating layers 60. The plurality of power-generating elements 50 are laminated. The plurality of insulating layers 60 are located separately at ends of each of the plurality of power-generating elements 50 in planar view. That is, the battery 200 has a structure in which a plurality of batteries 100 according to the present embodiment are laminated.

The plurality of power-generating elements 50 are laminated so as to be electrically connected in series to each other. Further, adjacent ones of the plurality of power-generating elements 50 are laminated with a collector 11 and a collector 21 sandwiched therebetween. The plurality of power-generating elements 50 are laminated such that the electrode layer 10 of one of the adjacent power-generating elements 50 and the counter-electrode layer 20 of the other of the adjacent power-generating elements 50 are electrically connected to each other via a collector.

The plurality of power-generating elements 50 are laminated such that the layers of all power-generating elements 50 are aligned in the same direction. Therefore, the electrode layer 10 of one of the adjacent power-generating elements 50 and the counter-electrode layer 20 of the other of the adjacent power-generating elements 50 face each other with no solid electrolyte layer 30 sandwiched therebetween.

It should be noted that only either a collector 11 or a collector 21 may be disposed between adjacent power-generating elements 50. That is, an electrode layer 10 may be laminated on one principal surface of one collector, and a counter-electrode layer 20 may be laminated on the other principal surface of the collector.

In the example shown in FIG. 17, the number of power-generating elements 50 is 3. However, the number of power-generating elements 50 is not limited to particular numbers. The number of power-generating elements 50 may be 2 or may be larger than or equal to 4.

The plurality of insulating layers 60 are located separately at ends of each of the plurality of power-generating elements 50 in planar view. Therefore, a first insulating film 61 is located between the collector 11 and the electrode active material layer 12 of each of the plurality of power-generating elements 50. Further, the side surface 51 of each of the plurality of power-generating elements 50 is covered with a second insulating film 62.

Thus, in the battery 200, the insulating layers 60 are located separately at ends of each of the plurality of power-generating elements 50 laminated so as to be electrically connected in series to each other. This makes it possible to achieve a high-voltage and highly reliable battery 200.

It should be noted that the battery 200 may have a structure in which batteries according to modifications of the embodiment are laminated instead of the batteries 100.

The battery 200 is manufactured, for example, by laminating a plurality of batteries 100 such that the electrode layer 10 of one of batteries 100 adjacent to each other in the direction of laminating and the counter-electrode layer 20 of the other of the batteries 100 face each other.

Further, the battery 200 may be formed by first laminating laminated bodies including laminated bodies 110 in the manufacturing method examples of the aforementioned method for manufacturing a battery 100 such that the laminated bodies are electrically connected in series to each other and then cutting the laminated bodies at a position that passes through the insulators 70. Specifically, in the laminated body forming step, a plurality of laminated bodies 110 are laminated so that there is an overlap in position between the insulators 70 in planar view. Then, in the cutting step, the plurality of laminated bodies 110 thus laminated are all cut at once at a position that passes through the respective insulators 70 of the plurality of laminated bodies 110 thus laminated. This makes it possible to, simply by cutting the plurality of laminated bodies 110 at once, manufacture a battery 200 having a plurality of insulating layers 60. Further, laminated bodies 110a, laminated bodies 110b, and laminated bodies 110c may be used instead of the laminated bodies 110.

### Modification

The following describes a modification of Embodiment 2.

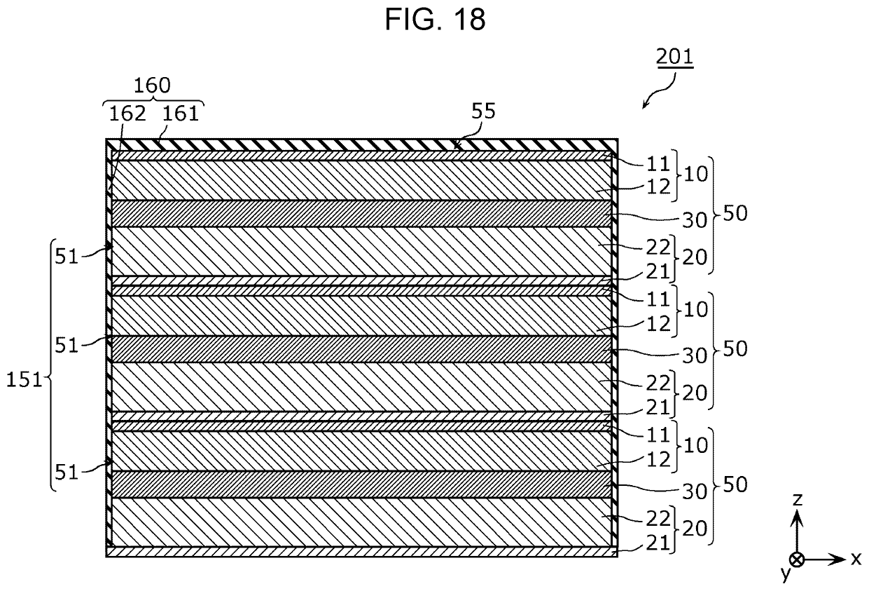

FIG. 18 is a cross-sectional view showing an example of a battery according to the present modification. As shown in FIG. 18, the battery 201 according to the present modification includes a plurality of power-generating elements 50 and an insulating layer 160.

As is the case with the battery 200 according to Embodiment 2, the plurality of power-generating elements 50 are laminated so as to be connected in series to each other. In the present modification too, only either a collector 11 or a collector 21 may be disposed between adjacent power-generating elements 50.

The respective side surfaces 51 of the plurality of power-generating elements 50 have portions located in the same plane as each other, and constitute one surface 151. That is, the surface 151 is a surface on which the respective side surfaces 51 of the plurality of power-generating elements 50 are continuous with each other. The surface 151 can also be said to be a side surface of a power-generating element laminated body having a structure in which the plurality of power-generating elements 50 are laminated.

The insulating layer 160 includes a first insulating film 161 and a second insulating film 162. The second insulating film 162 is thinner than the first insulating film 161.

The first insulating film 161 is positioned to extend inward from ends of a power-generating element 50 in a planar view of the principal surface 55. The first insulating film 161 extends inward from the ends of the power-generating element 50, for example, along a direction parallel with the principal surface 55. The first insulating film 161 overlaps the power-generating element 50 in planar view.

Further, the first insulating film 161 faces the electrode active material layer 12 of the uppermost one of the plurality of power-generating elements 50 across the collector 11 of the uppermost power-generating element 50. A lower surfaces of the first insulating film 161 is in contact with the collector 11 of the uppermost power-generating element 50. Further, the first insulating film 161 covers the whole of the upper principal surface 55 of the uppermost power-generating element 50. It should be noted that the first insulating film 161 may cover only part of the principal surface 55 of the uppermost power-generating element 50.

The second insulating film 162 covers the surface 151 constituted by the respective side surfaces 51 of the plurality of power-generating elements 50 and is continuous with ends of the first insulating film 161. The second insulating film 162 continuously covers the respective side surfaces 51 of the plurality of power-generating elements 50. The second insulating film 162 is continuous with the ends of the first insulating film 161 on the outer peripheries of the power-generating elements 50 in planar view. The second insulating film 162 extends downward along the surface 151 from the ends of the first insulating film 161. This causes the surface 151 to be protected by the second insulating film 162. Further, the second insulating film 162 is disposed, for example, to surround the plurality of power-generating elements 50 from the sides.

The second insulating film 162 continuously covers the side surfaces 51 of all power-generating elements 50 that the battery 201 includes. On the surface 151, the respective electrode active material layers 12, solid electrolyte layers 30, and counter-electrode active material layers 22 of the plurality of power-generating elements 50 are all covered with the second insulating film 162. The overall protection of the respective side surfaces 51 of the plurality of power-generating elements 50 by the second insulating film 162 brings about improvement in reliability of the battery 201. It should be noted that a region on the surface 151 that the second insulating film 162 covers is not limited to a particular region. The second insulating film 162 may cover only the side surfaces 51 of some power-generating elements 50 on the surface 151.

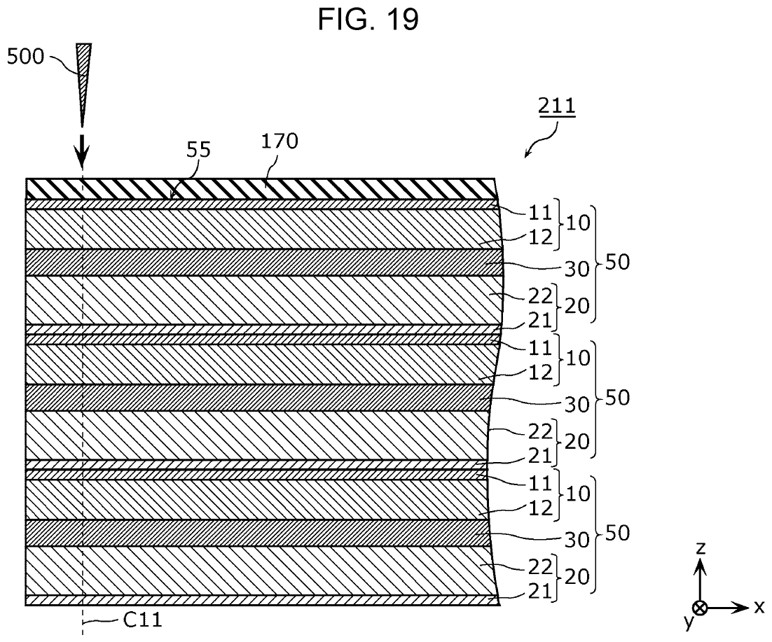

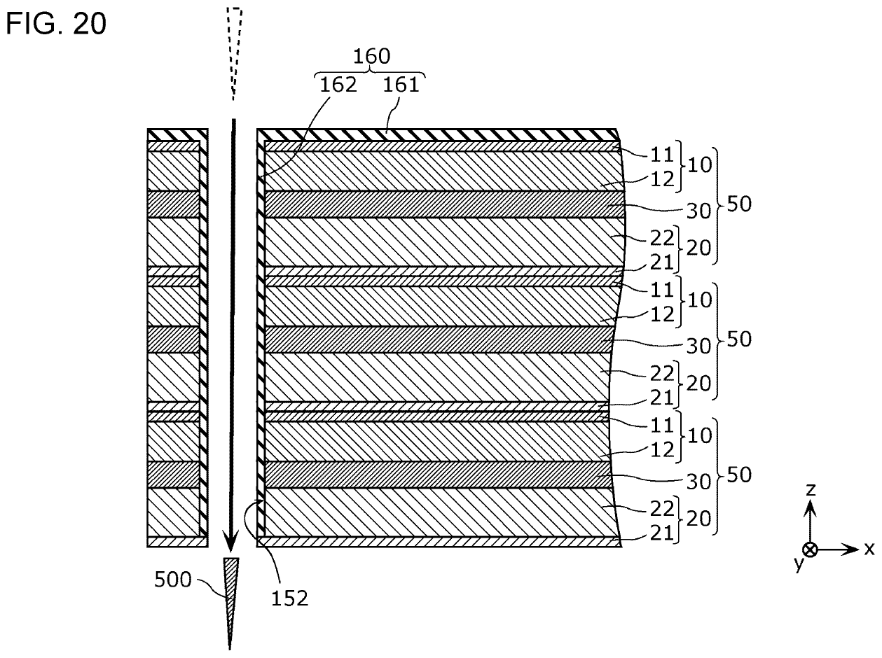

The battery 201 is manufactured, for example, by the following method. FIG. 19 is a cross-sectional view showing an example of a laminated body in a method for manufacturing a battery according to the present modification. FIG. 20 is a cross-sectional view for explaining a cutting step of the method for manufacturing a battery according to the present modification. It should be noted that FIGS. 19 and 20 each show a cross-section of part of a laminated body 211.

First, in a laminated body forming step of the method for manufacturing a battery 201, as shown in FIG. 19, a laminated body 211 including a plurality of power-generating elements 50 and an insulator 170 placed in a position that overlaps a power-generating elements 50 in a planar view of a principal surface 55 of the power-generating element 50 is formed.

In the formation of the laminated body 211, first, the coating method described in Embodiment 1 or other methods are used to form a power-generating element 50 by sequentially laminating a collector 11, an electrode active material layer 12, a solid electrolyte layer 30, a counter-electrode active material layer 22, and a collector 21 in this order. A plurality of the power-generating elements 50 are formed in this way, and the plurality of power-generating elements 50 thus formed are laminated. Next, an insulator 170 is formed on top of the upper principal surface 55 of the uppermost one of the plurality of power-generating elements 50 thus laminated. Therefore, the insulator 170 faces the electrode active material layer 12 of the uppermost one of the plurality of power-generating elements 50 across the collector 11 of the uppermost power-generating element 50. The insulator 170 is formed, for example, to cover the whole of the upper principal surface 55. This gives a laminated body 211. The insulator 170 is constituted by a material that is similar to that by which the insulator 70 is constituted in Embodiment 1, and can be formed by a method that is similar to that by which the insulator 70 is formed.

Next, as shown in FIG. 19, in the cutting step, a cutting edge 500 is used to cut the laminated body 211 in a direction across the principal surface 55 of the power-generating element 50 so that the cutting edge 500 passes through the insulator 170. In the example shown in FIG. 19, the laminated body 211 is cut along a direction orthogonal to the principal surface 55 of the power-generating element 50 (i.e., the direction of laminating) at a position C11 that passes through the insulator 170 and where all of the plurality of power-generating elements 50 are cut at once. This makes it unnecessary to laminate the plurality of power-generating elements 50 in shapes into which they have been cut, thus making it possible to easily manufacture a battery 201.

Further, as shown in FIG. 20, a cut surface 152 of the plurality of power-generating elements 50 is formed by cutting the laminated body 211.

Further, the cutting step includes cutting the laminated body 211 while applying the insulator 170 to the cut surface 152 with the cutting edge 500. Specifically, cutting down the laminated body 211 with the cutting edge 500 moving from the side of the plurality of power-generating elements 50 that faces the insulator 170, i.e., from above the insulator 170, causes the insulator 170 to be applied to the cut surface 152, which is located at a lower level than the insulator 170, by the cutting edge 500. Passage of the cutting edge 500 through the flowable insulator 170 causes the insulator 170 to adhere to the cutting edge 500 and causes the insulator 170 adhering to the cutting edge 500 to be spread over the cut surface 152 while the cut surface 152 is being formed. This results in the formation of an insulating layer 160 including a second insulating film 162 that is a portion of the insulator 170 applied to the cut surface 152 and a first insulating film 161 that is a portion of the insulator 170 that remains on top of the principal surface 55. The cut surface 152 serves as a surface 151 of the battery 201. Through the laminated body forming step and the cutting step, the battery 201 is manufactured.

Since the insulator 170 is applied to the cut surface 152 at the time of cutting in the cutting step of such a method for manufacturing a battery 201, a battery 201 in which the principal surface 55 and the surface 151 are protected by the insulating layer 160 can be easily manufactured with a small number of steps.

Although the foregoing has described the formation of one cut surface 152 in the cutting step, a plurality of cut surfaces may be formed in a manner similar to that described above. For example, all side surfaces of the power-generating elements 50 are formed by the aforementioned cutting step.

### OTHER EMBODIMENTS

In the foregoing, a battery according to the present disclosure and a method for manufacturing the same have been described with reference to embodiments; however, the present disclosure is not intended to be limited to these embodiments. Applications to the present embodiments of various types of modification conceived of by persons skilled in the art and other embodiments constructed by combining some constituent elements of the embodiments are encompassed in the scope of the present disclosure, provided such applications and embodiments do not depart from the spirit of the present disclosure.

Further, although, in each of the foregoing embodiments, the first insulating film 61 is in the shape of a frame located on the outer periphery of the power-generating element 50 in planar view, this is not intended to impose any limitation. For example, there may be a region on the outer periphery of the power-generating element 50 where the first insulating film 61 is not provided.

Further, although, in each of the foregoing embodiments, the collector 11, the electrode active material layer 12, the solid electrolyte layer 30, the counter-electrode active material layer 22, and the collector 21 are substantially identical in shape and position to one another in planar view, this is not intended to impose any limitation. At least one of the collector 11, the electrode active material layer 12, the solid electrolyte layer 30, the counter-electrode active material layer 22, and the collector 21 may be substantially different in shape or position in planar view. For example, the collector 11 and the collector 21 may have terminals that project from ends end of the electrode active material layer 12 and the counter-electrode active material layer 22 in planar view and through which the collector 11 and the collector 21 are connected to leads or other wires. In other words, the collector 11 and the collector 21 may have regions disposed outside the electrode active material layer 12 and the counter-electrode active material layer 22 in planar view.

Further, although, in each of the foregoing embodiments, the second insulating film 62 or the second insulating film 162 is formed by applying the insulator 70 or the insulator 170 to the cut surface with the cutting edge 500 in the cutting step, this is not intended to impose any limitation. The second insulating film 62 or the second insulating film 162 may be formed by separately applying an insulating material to the cut surface.

Further, although, in each of the foregoing batteries 200 and 201, the plurality of power-generating elements 50 are laminated so as to be electrically connected in series to each other, this is not intended to impose any limitation. The plurality of power-generating elements 50 may be laminated so as to be electrically connected in parallel to each other. In this case, the plurality of power-generating elements 50 are laminated such that the same poles of adjacent ones of the power-generating elements 50 are electrically connected to each other via the collector 11 or the collector 21. This makes it possible to achieve a high-capacitance and highly reliable battery.

Further, the foregoing embodiments are subject, for example, to various changes, substitutions, additions, and omissions in the scope of the claims or the scope of equivalents thereof.

A battery according to the present disclosure may be used as a secondary battery such as an all-solid battery for use, for example, in various types of electronics or automobiles.

What is claimed is:

1. A battery comprising:
a power-generating element including an electrode layer, a counter-electrode layer placed to face the electrode layer, and a solid electrolyte layer located between the electrode layer and the counter-electrode layer; and
an insulating layer,
wherein
the insulating layer includes:
a first insulating film that extends inward from ends of the power-generating element in a planar view of a principal surface of the power-generating element; and
a second insulating film that covers a side surface of the power-generating element and that is continuous with ends of the first insulating film, and
the second insulating film is thinner than the first insulating film.

2. The battery according to claim 1, wherein
the electrode layer includes:
an electrode collector; and
an electrode active material layer located between the electrode collector and the solid electrolyte layer, and
the first insulating film is located between the electrode collector and the electrode active material layer.

3. The battery according to claim 2, wherein the second insulating film covers the electrode active material layer and the solid electrolyte layer on the side surface of the power-generating element.

4. The battery according to claim 1, wherein
the electrode layer includes:
an electrode collector; and
an electrode active material layer located between the electrode collector and the solid electrolyte layer, and
the first insulating film is located between the electrode active material layer and the solid electrolyte layer.

5. The battery according to claim 2, wherein
the electrode layer is a positive-electrode layer, and
the counter-electrode layer is a negative-electrode layer.

6. The battery according to claim 2, wherein the first insulating film is located in a region where a length of the electrode active material layer from an outer periphery in a plan view of the principal surface of the power-generating element is shorter than or equal to 1 mm.

7. The battery according to claim 2, wherein the second insulating film includes a first portion extending from the ends of the first insulating film in a first direction along the side surface of the power-generating element and a second portion extending from the ends of the first insulating film in a second direction opposite to the first direction along the side surface of the power-generating element.

8. The battery according to claim 1, wherein
the electrode layer includes:
an electrode collector; and
an electrode active material layer located between the electrode collector and the solid electrolyte layer, and
the first insulating film faces the electrode active material layer across the electrode collector.

9. The battery according to claim 8, wherein the second insulating film covers the electrode collector, the electrode active material layer, and the solid electrolyte layer on the side surface of the power-generating element.

10. The battery according to claim 1, wherein the insulating layer contains resin.

11. The battery according to claim 1, wherein
the second insulating film covers a region of the side surface of the power-generating element, and
a region of the side surface of the power-generating element that is not covered with the second insulating film and a surface of the second insulating film that faces away from the power-generating element are flush with each other.

12. The battery according to claim 1, wherein a thickness of the second insulating film becomes smaller away from the first insulating film.

13. The battery according to claim 1, wherein the solid electrolyte layer contains a solid electrolyte having lithium ion conductivity.

14. A method for manufacturing a battery, the method comprising:
forming a laminated body including a power-generating element in which an electrode layer, a counter-electrode layer placed to face the electrode layer, and a solid electrolyte layer located between the electrode layer and the counter-electrode layer are laminated and an insulator placed in a position that overlaps the power-generating element in a planar view of a principal surface of the power-generating element; and
cutting the laminated body with a cutting edge in a direction across the principal surface of the power-generating element so that the cutting edge passes through the insulator and thereby forming a cut surface of the power-generating element,
wherein the cutting includes cutting the laminated body while applying the insulator to the cut surface with the cutting edge.

15. The method according to claim 14, wherein the cutting includes cutting the laminated body while applying a pressure to the laminated body in a direction of laminating.

16. The method according to claim 14, wherein
the insulator is constituted by a thermoplastic material, and
the cutting includes cutting the laminated body after heating at least one of the laminated body or the cutting edge to a temperature that is higher than or equal to a softening point of the insulator.

17. The method according to claim 16, wherein in the cutting, the temperature is lower than or equal to 300° C.

18. The method according to claim 16, wherein
the cutting includes heating both the laminated body and the cutting edge, and
the heating of the laminated body and the cutting edge includes heating the laminated body to a first temperature and heating the cutting edge to a second temperature that is higher than the first temperature.

19. The method according to claim 14, wherein
the insulator is constituted by a thermosetting material or a photocurable material, and
the cutting includes curing the insulator after cutting the laminated body.

20. The method according to claim 14, wherein the forming includes forming the laminated body by inserting the insulator into a side surface of the power-generating element.
